(19) United States
(12) Patent Application Publication
(10) Pub. No.: US 2017/0125807 A1
(43) Pub. Date: May 4, 2017

(54) Layered Metal Oxide Cathode Material for Lithium Ion Batteries

(71) Applicant: Northeastern University, Boston, MA (US)

(72) Inventors: Mehmet Nurullah ATES, Savoy, IL (US); Kuzhikalail M ABRAHAM, Needham, MA (US); Sanjeev MUKERJEE, Mansfield, MA (US)

(73) Assignee: Northeastern University, Boston, MA (US)

(21) Appl. No.: 15/317,509

(22) PCT Filed: Jun. 15, 2015
(86) PCT No.: PCT/US15/35896

§ 371 Date: Dec. 9, 2016

Related U.S. Application Data
(60) Provisional application No. 62/011,634, filed on Jun. 13, 2014.

(51) Int. Cl. H01M 4/505; C01G 45/12; H01M 4/36; C01G 53/00; H01M 10/0525; H01M 4/525

(52) U.S. Cl. CPC H01M 4/505; H01M 10/0525; H01M 4/525; H01M 4/362; C01G 53/50; C01G 45/1257; H01M 2004/028

(57) ABSTRACT

The invention provides a cathode material for L1-ion batteries. The material has the formula of 0.5Li₂MnO₃-0.5LiM-n_{0.5}Ni_{0.35}Co_{0.15}O₂. The material was synthesized using the “self-ignition combustion” method, which previously has not been used for the preparation of Li-rich layered metal oxides. The cathode material exhibits capacities of 290, 250, and 200 mAh/g at discharge rates of C/20, C/4 and C rates, respectively. Moreover, the new material exhibits high rate cycling ability with little or no capacity fade for over 100 cycles demonstrated at a series of rates from C/20 to 2C rates for electrodes loadings of 7-8 mg/cm².

### STATEMENT REGARDING FEDERALLY SPONSORED RESEARCH OR DEVELOPMENT

The invention was developed with financial support from Grant No. P30-EB-009998 from the National Institute of Biomedical Imaging and Bioengineering of the National Institutes of Health, and Contract No. GTS-S-14-164 from U.S. Army CERDEC. The U.S. Government has certain rights in the invention.

### BACKGROUND

The family of lithium-rich transition metal oxides of the general formula xLi₂MnO₃-(1−x)LiMO₂, where M is a transition metal, in which a layered lithium manganate (Li₂MnO₃); is interspersed with a layered lithium metal oxide (LiMO₂), offers promise as cathode materials for Li-ion batteries. These materials can deliver discharge capacities of greater than 250 mAh/g at low to medium discharge rates of C/5 to C/20. In the initial charging of these materials, Li is extracted from the layered LiMO₂ structure up to a voltage of about 4.4V, and then the Li₂MnO₄ structural unit is activated with the extraction of Li₂O as Li⁺, O₂, and electrons at potentials between 4.6 and 4.9 V. However, several disadvantages of these materials still remain to be resolved before they can be implemented in practical batteries, including: (i) the high irreversible capacity loss along with oxygen generation in the initial activation charging; (ii) low discharge rate capability and high capacity fade during cycling; (iii) low electronic conductivity, leading to high resistance in Li-ion cells; and (iv) voltage hysteresis and phase transformation after extended cycling.

### SUMMARY OF THE INVENTION

The invention provides a cathode material for LI-ion batteries. The material has the formula of 0.5Li₂MnO₃-0.5LiMn_{0.5}Ni_{0.35}Co_{0.15}O₂, which can be written alternatively as Li_{1.2}Mn_{0.6}Ni_{0.14}Co_{0.06}O₂. The material was synthesized using the “self-ignition combustion” method, which previously has not been used for the preparation of Li-rich layered metal oxides. This new cathode material exhibits capacities of 290, 250, and 200 mAh/g at discharge rates of C/20, C/4 and C rates, respectively. Moreover, the new material exhibits high rate cycling ability with little or no capacity fade for over 100 cycles demonstrated at a series of rates from C/20 to 2C rates for electrodes loadings of 7-8 mg/cm².

The material exhibits exceptional electrochemical performance for a high capacity Li-rich layered metal composite oxide cathode material. The unprecedented cycling stability of the material at C and 2C is suitable as synthesized for electric vehicle batteries,and also at the moderate C/20 and C/4 rates desirable for powering portable electronic devices such as cell phones and laptop computers. The superior electrochemical properties of the new material are ascribed to its unique particle morphology, high porosity, and electronic conductivity achieved from the self-ignition combustion synthesis.

One aspect of the invention is a cathode material for a lithium ion battery. The cathode material includes a layered-layered Li₂MnO₃—LiMO₂ material, wherein M is a transition metal or combination of transition metals. The material is made by a process comprising self-ignition combustion.

Another aspect of the invention is a lithium ion battery containing the cathode material described above.

Yet another aspect of the invention is a method of method of making a cathode material for a lithium ion battery. The method includes the following steps: (a) providing an aqueous solution comprising one or more transition metal salts, nitric acid, and a self-ignition combustion fuel, wherein at least one of the transition metal salts is an acetate salt; (b) heating the solution from (a) to initiate a self-ignition combustion reaction, whereby a porous metal oxide scaffold is formed; (c) adding a lithium precursor to the porous metal oxide scaffold from (b) to form a mixture and grinding the mixture; and (d) heating the ground mixture from (c) to form the cathode material.

Further embodiments of the invention are summarized in the following listing of items.
1. A cathode material for a lithium ion battery, the material comprising a layered-layered Li₂MnO₃—LiMO₂ material, wherein M is a transition metal or combination of transition metals, and wherein the material is made by a process comprising self-ignition combustion.
2. The cathode material of item 1, wherein the transition metal is selected from the group consisting of Mn, Co, Ni.
3. The cathode material of any one of the preceding items, wherein M is a combination of Mn, Co, and Ni.
4. The cathode material of any one of the preceding items, wherein said layered-layered Li₂MnO₃—LiMO₂ material has the formula 0.5Li₂MnO₃-0.5LiMn_{0.5}Ni_{0.35}Co_{0.15}O₂.
5. The cathode material of any one of the preceding items having a surface area in the range from about 3.50 to about 3.95 m²/g.
6. The cathode material of any one of the preceding items having an open interconnected micropore structure.
7. The cathode material of any one of the preceding items having an average pore size in the range from about 150 to about 200 angstroms.
8. The cathode material of any one of the preceding items comprising particles of about 100 nm size agglomerated to particles of about 200 nm to about 250 nm size.
9. The cathode material of any one of the preceding items that is made by a process that does not include co-precipitation.
10. A lithium ion battery comprising the cathode material of any one of the preceding items.
11. The lithium ion battery of item 10 that has a discharge capacity of at least 200 mAh/g at a discharge rate of C.
12. The lithium ion battery of any one of items 10-11 that has a discharge capacity of at least 245 mAh/g at a discharge rate of C/4.
13. The lithium ion battery of any one of items 10-12 that has a discharge capacity of about 280 mAh/g at a discharge rate of C/20.
14. The lithium ion battery of any one of items 10-13 that has a specific energy of at least 400 Wh/kg.
15. The lithium ion battery of any one of items 10-14 that has an energy density of at least 1000 Wh/L.
16. The lithium ion battery of any one of items 10-15 that retains essentially 100% of its initial discharge capacity after 100 charge/discharge cycles.
17. The lithium ion battery of any one of items 10-16, wherein the impedance of the battery does not substantially increase after 100 charge/discharge cycles.
18. The lithium ion battery of any one of items 10-17, wherein the DC conductivity is in the range from about 5×10⁻⁶ to about 9×10⁻⁶ S/cm.
19. A method of making a cathode material for a lithium ion battery, the method comprising the steps of:
   (a) providing an aqueous solution comprising one or more transition metal salts, nitric acid, and a self-ignition combustion fuel, wherein at least one of the transition metal salts is an acetate salt;
   (b) heating the solution from (a) to initiate a self-ignition combustion reaction, whereby a porous metal oxide scaffold is formed;
   (c) adding a lithium precursor to the porous metal oxide scaffold from (b) to form a mixture and grinding the mixture; and
   (d) heating the ground mixture from (c) to form the cathode material.
20. The method of item 19, wherein the transition metal salts are selected from salts of Mn, Ni, Co, and combinations thereof.
21. The method of any one of items 19-20, wherein the solution provided in (a) comprises salts of Mn, Ni, and Co.
22. The method of any one of items 19-21, wherein the salt of Mn is Mn(Ac)₂.4H₂O, the salt of Ni is Ni(NO₃)₂.6H₂O, and the salt of Co is Co(NO₃)₂.6H₂O.
23. The method of any one of items 19-22, wherein the lithium precursor added in (c) is LiOH.H₂O.
24. The method of any one of items 19-23, wherein the molar ratio of acetate ions to nitric acid is about 1:1.
25. The method of any one of items 19-24, wherein the self-ignition combustion fuel is glycine.
26. The method of any one of items 19-25, wherein the molar ratio of nitric acid to glycine is about 6:1.
27. The method of any one of items 19-26, wherein the molar ratio of nitrate ions to glycine is about 8:1.
28. The method of any one of items 19-27, wherein the solution is heated in step (b) to about 120° C. for about 1 to 2 hours.
29. The method of any one of items 19-28, wherein step (d) comprises heating the mixture to about 480° C. for about 3 hours, cooling and pressing the mixture into pellets, and heating the pellets to about 900° C. for about 3 hours.
30. The method of any one of items 19-29, wherein precipitation of the transition metals is avoided during step (b).
31. The method of any one of items 19-30, wherein steps (a) and (b) of the method do not include co-precipitation of the transition metal(s) or the Li precursor.
32. The method of any one of items 19-31, wherein the amount of acetate in the solution of step (a) is sufficient to create an open interconnected microporous structure in the resulting metal oxide scaffold.
33. The method of any one of items 19-32, wherein the amount of lithium precursor added in step (c) is stoichiometric with the amount of one or more of the transition metals provided in step (a).
34. The method of any one of items 19-33, wherein the cathode material formed in step (d) is a layered-layered Li₂MnO₃—LiMO₂ material.
35. The method of item 34, wherein the layered-layered Li₂MnO₃—LiMO₂ material is 0.5Li₂MnO₃-0.5LiMn_{0.5}Ni_{0.35}Co_{0.15}O₂.
36. The method of any one of items 19-35, wherein the cathode material formed in step (d) has a surface area in the range from about 3.50 to about 3.95 m²/g.
37. The method of any one of items 19-36, wherein the cathode material formed in step (d) has an average pore size in the range from about 150 to about 200 angstroms.
38. The method of any one of items 19-37 wherein the cathode material formed in step (d) comprises particles of about 100 nm size agglomerated to particles of about 200 nm to about 250 nm size.

### BRIEF DESCRIPTION OF THE DRAWINGS

FIG. 1 depicts the reaction scheme for preparing a layered lithium manganese nickel cobalt oxide (LLMNC) cathode material according to the invention by a self-ignition combustion (SIC) process.

FIG. 2A shows an FESEM image of a metal oxide sponge-like framework (product of SIC reaction, also referred to as MO), and FIG. 2B shows an FESEM image of pristine LLMNC material (also referred to as SIC-MNC) after final heat treatment. FIG. 2C shows an EDS spectrum and mapping results of SIC-MNC. FIG. 2D shows bright field images with magnified region where further investigation was performed. FIG. 2E shows an HRTEM image revealing lattice fringes associated with (001) and/or (003) planes. FIG. 2F shows an as generated cross-sectional profile of the HRTEM fringe presented in FIG. 2E used to calculate the width between lattice fringes.

FIG. 3A shows X-ray diffraction (XRD) patterns associated with MO and final SIC-MNC at 900° C., including major planes based on two different space groups. FIG. 3B shows SAED (selected area electron diffraction) ring-pattern unveiling the polycrystalline nature of SIC-MNC along with calculated d-spacing values based on two different techniques. FIG. 3C shows SAED pattern of a single crystal of SIC-MNC, yielding the existence of weak reflections corresponding to C2/m phase group. FIG. 3D shows a simulated SAED pattern of Li₂MnO₃ structure along with [001] zone directions. Structural demonstration in real-time was also generated from the pattern and shown at the bottom left corner of the picture.

FIG. 4 shows XRD evolution with respect to morphological changes observed by FESEM showing interconnected particles even after final heat treatment.

FIG. 5 shows the cycling and rate performance of a Li cell with a co-precipitated MNC material (CP-MNC) cycled between 2 and 4.9V at room temperature.

FIG. 6A shows the electrochemical cycling performance at C discharge rate (280 mA/g) between 2 and 4.9 V. The inset shows different discharge rate and C/4 rate cycling performance. Each figure's data were obtained from different cells having similar loading. FIG. 6B shows cyclic voltammograms of SIC-MNC recorded at a sweep rate of 100 mV/s. FIG. 6C shows charge-discharge curves at C/20 deduced from the data in FIG. 6A. FIG. 6D shows charge-discharge profiles of both SIC-MNC and CP-MNC and their voltage fade performance.

FIG. 7 shows Nyquist plots of fresh Li cells prepared with SIC-MNC and CP-MNC at room temperature.

FIGS. 8A-8C shows FESEM images of SIC-MNC cathodes collected after first (FIG. 8A), 41st (FIG. 8B) and 100th (FIG. 8C) cycles, each discharged to 2V. The bottom images show low magnifications while the upper images show high magnifications. EDS results are depicted in FIG. 8D.

FIG. 9A shows a HRTEM image along with FFT pattern during the first charging at 4.9V. Further HRTEM images display lattice fringes at 4.3V (FIG. 9B) and 4.9V (FIG. 9C) during the first charge, and at 2V during the first discharge (FIG. 9D).

FIG. 10A shows ex situ XRD patterns of cycled and pristine cathode materials. The table in FIG. 10B shows unit cell parameters belonging to each region indicated in the examples. Crystal lattice visualization (FIG. 10C) was drawn to understand the reaction taking place in each voltage region.

FIGS. 11A-11C show selected ex situ XANES spectra during the first cycles of Mn—K edge (FIG. 11A), Co—K edge (FIG. 11B), and Ni—K edge (FIG. 11C) along with respective references. FIG. 11D shows magnitude of the Fourier transformed (FT) Ni—K edge spectra along with metal oxygen framework.

FIG. 12A shows charge-discharge profiles of the first 40 cycles at 1C rate for a Li cell containing SIC-MNC cathode material of the invention. FIG. 12B shows charge-discharge profiles for further cycles at 1C rate. FIG. 12C shows differential capacity plots of the data presented in FIG. 12A. FIG. 12D shows differential capacity plots of the data presented in FIG. 12B. All tests were performed at room temperature, between 2 and 4.9 V.

FIG. 13A shows ex situ XRD patterns of pristine SIC-MNC, and SIC-MNC after the first cycle and 100 cycles cutoff at 2 V. FIG. 13B shows a HRTEM image of SIC-MNC after 100 cycles and corresponding FT pattern along with the simulated R3m phase in approximately [110] zone axis.

FIG. 14A shows charge-discharge profiles of the first 60 cycles at 2C rate. FIG. 14B shows charge-discharge profiles for further cycles at 2C rate. FIG. 14C shows ex situ XRD patterns of SIC-MNC in pristine state, after 100 cycles at 2C rate under ambient temperature, and after 24 cycles at 50° C. with C/4 rate. FIG. 14D shows an HRTEM image of SIC-MNC after 130 cycles at 2C rate under ambient temperature and corresponding FT pattern along with the simulated Fd3m spinel phase in [311] zone axis. Crystal lattice visualization was drawn in order for readers to understand conversion phenomena.

FIG. 15 shows XANES profiles of each transition metal (Ni at left, Co middle, Mn right) after the first cycle and after 41 cycles at room temperature.

### DETAILED DESCRIPTION OF THE INVENTION

Lithium-rich layered composite metal oxides of the general formula Li₂MnO₃—LiMO₂ made by a self-induced combustion method have superior properties when used as cathode material for Li-ion batteries. For example, 0.5Li₂MnO₃-0.5LiMn_{0.5}Ni_{0.35}Co_{0.15}O₂, or alternatively formulated as Li_{1.2}Mn_{0.5}Ni_{0.14}Co_{0.06}O₂ was synthesized for the first time by the self-ignition combustion method, and found to have a discharge capacity as high as 290 mAh/g. This and related materials have excellent charge/discharge rate capabilities with little or no capacity fade with cycling, making them candidates for Li-ion batteries suitable for powering electric vehicles and portable consumer products. The cathode materials of the invention have an open, interconnected pore, particulate morphology combined with high electronic conductivity. The highly desirable Li cell electrochemistry of these materials has been reinforced by structural information obtained from FESEM, XRD, HRTEM, SAED, and XAS measurements.

Materials of the formula Li₂MnO₃—LiMO₂ have previously been made by co-precipitation methods; however, as previously mentioned, the materials resulting from co-precipitation methods have been deficient in their battery performance, particularly in their loss of discharge capacity with cycling. The present inventors have taken a different approach, employing a “self-induced combustion” method to form a scaffold of the LiMO₂ portion, followed by separate formation of the Li₂MnO₃ portion. The result is a “layered-layered” material has a distinct structure from that of previous layered-layered Li₂MnO₃—LiMO₂ materials, a structure that provides superior function as a Li-ion battery cathode material.

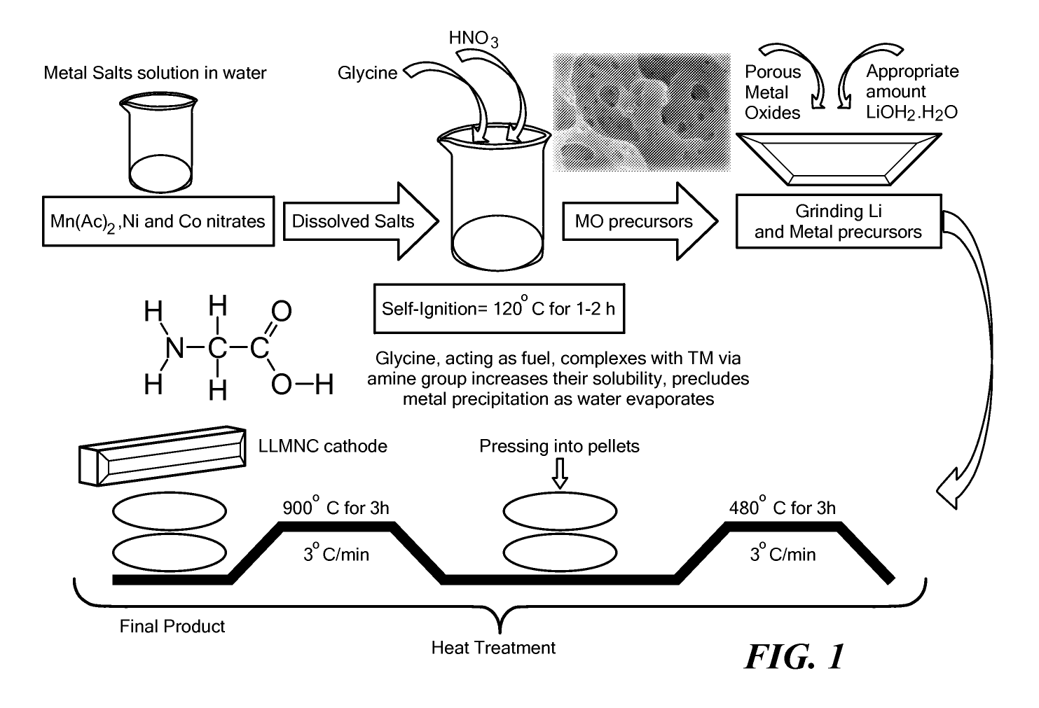

The process for preparing Li₂MnO₃—LiMO₂ materials of the present invention is shown schematically in FIG. 1 and described in practice in Example 1. The first step is to perform the self-induced combustion reaction, which forms a transition metal oxide scaffold. An important factor in the reaction is the inclusion of acetate anion, or another gas-forming substrate, so as to produce the requisite porosity of the scaffold. Another important factor is the ratio of acetate to nitric acid. Preferably the ratio is in the range from about 0.5 to 2.0, more preferably 1:1. The fuel for the reaction can be, for example, glycine, preferably present at a ratio of nitric acid to glycine of about 4 to about 8, more preferably about 6:1. The total molar ratio of nitrate ions to glycine is preferably about 6 to about 10, more preferably about 8:1. Any transition metal ions can be included in the reaction; however, mixtures of salts of manganese, nickel, and cobalt are preferred. Various molar ratios of transition metals can be used. After formation of the scaffold, the scaffold material is ground and mixed with a suitable Li precursor, which can be, for example, a salt or hydroxide of Li, such as LiOH. The mixture is then subjected to calcination and pelleting to form the final product.

The structure of material of the Li₂MnO₃—LiMO₂ material is characterized by an agglomeration of nanoparticles, which are principally of two size classes. The larger particles are preferably on the order of about 200 nm to about 250 nm in average diameter, while the smaller particles are preferably on the order of about 100 nm in average diameter. The structure on a larger scale is characterized by a network of open, interconnected pores having a size in the micrometer range, i.e., from about 1 micron to about 999 microns or larger. However, the agglomerated nanoparticles produce an additional smaller class of pores, such that the average pore size for the material is preferably in the range from about 150 angstroms to about 200 angstroms. The scaffold together with the nanoparticulate structure result in a high surface area of about 3.50 to about 3.95 m²/g. Without intending to limit the invention to any particular mechanism, it is believed that the combination of open microporous structure, high surface area, and high average pore size contribute to the high performance of the material as cathode in Li-ion batteries.

Li-ion batteries using the cathode material of the invention are characterized by retention of substantially all (i.e. at least 80%, 85%, 90%, 95%, 98%, 99%, or essentially 100%) of their initial discharge capacity at a discharge rate of C/20 to C, where C is the theoretical discharge capacity of about 280 mA/g in one hour. Further properties include an impedance that does not substantially increase after 100 cycles or more, a DC conductivity in the range from about 5×10⁻⁶ to about 9×10⁻⁶ S/cm, a specific energy of at least 400 Wh/kg, and an energy density of at least 1000 Wh/L.

Further features of the invention are provided by the following non-limiting examples.

### EXAMPLES

### Example 1

### Preparation of Cathode Material

The process for preparation of 0.5Li₂MnO₃-0.5LiMn_{0.5}Ni_{0.35}Co_{0.15}O₂ is depicted in FIG. 1. Appropriate amounts of Mn(Ac)₂.4H₂O (Sigma Aldrich >99%), Ni(NO₃)₂.6H₂O (Alfa Aesar-Puratronic), Co(NO₃)₂.6H₂O (Alfa Aesar-Puratronic) were dissolved in distilled water at room temperature in a beaker. Nitric acid and glycine (Sigma Aldrich >99%) were added to the solution and heated it to 120 C, whereupon the ignition combustion reaction took place. Different ratios of glycine, as a source of fuel, were used to optimize and control the combustion reaction. Glycine is known to be a complexing agent for transition metal ions due to the presence of both carboxylic acid and amino group in its structure. Acetate precursor was used in order to produce a large amount of gaseous by-product of the combustion reaction, whose evolution leads to a material with open porous microstructures. The material obtained from the combustion reaction was mixed in a mortar with stoichiometric amount of LiOH.H₂O (Alfa Aesar >99.995%). This mixture was placed in a ceramic boat and fired at 480 C for 3 h under air flow. Afterwards, the sample was slowly cooled, reground, pelletized and fired at 900 C for another 3 h in open air. This material hereafter is denoted as SIC-MNC. For comparison, the same compound was also synthesized using the conventional co-precipitation method, designated hereafter as CP-MNC. Details of the co-precipitation method can be found in the literature (Z. Lu, D. D. MacNeil and J. R. Dahn, Electrochem. Solid-State Lett., 2001, 4, A191-A194; M. N. Ates, Q. Jia, A. Shah, A. Busnaina, S. Mukerjee and K. M. Abraham, J. Electrochem. Soc., 2014, 161, A290-A301; M. N. Ates, S. Mukerjee and K. M. Abraham, J. Electrochem. Soc., 2014, 161, A355-A363; and C. S. Johnson, N. Li, C. Leftef, J. T. Vaughey and M. M. Thackeray, Chem. Mater., 2008, 20, 6095-6106. To prepare a Ni⁴⁺ reference material for XAS experiments, LiNi_{0.85}Co_{0.15}O₂ was synthesized via solid state reaction from appropriate amounts of LiOH.H₂O, Ni(Ac)₂.4H₂O and Co(Ac)₂.4H₂O as reported previously (X. J. Zhu, H. H. Chen, H. Zhan, D. L. Yang and Y. H. Zhou, J. Mater. Sci., 2005, 40, 2995-2997). Charging of this material in a Li cell to 5.1 V produced the Ni⁴⁺ reference material (M. Balasubramanian, X. Sun, X. Q. Yang and J. McBreen, J. Electrochem. Soc., 2000, 147, 2903-2909).

### Example 2

### Characterization of Cathode Material

The structure-property relationships of the high rate Li-rich MNC cathode material was characterized by means of XRD, FESEM along with Energy Dispersive Spectroscopy (EDS), XAS, and HRTEM, combined with electrochemical discharge-charge cycling tests and Electrochemical Impedance Spectroscopy (EIS) of Li cells. Diffraction patterns of the materials were obtained using a Rigaku Ultima IV diffractometer with CuKa radiation. Unit cells of each sample were analyzed by PDXL software program provided by Rigaku Corporation. VESTA software (K. Momma and F. Izumi, J. Appl. Crystallogr., 2011, 44, 1272-1276) were run to visualize unit cells in order to understand the reaction process. For ex situ XRD experiments, harvested electrodes from cycled Li cells were thoroughly rinsed with anhydrous dimethyl carbonate (DMC) to remove possible electrolyte residue before examination. Morphological and structural investigations were observed by Hitachi S-4800 FESEM combined with its EDS attachment and a JEOL 2010F model HRTEM was utilized for structural investigations. The samples for HRTEM were prepared by dispersing powders into an ethanol solution followed by a few minutes of sonication, and then one or two drops of the dispersed solution was dropped onto Cu grid. Electron diffraction patterns were simulated using SingleCrystal software developed by CrystalMaker software Limited, Oxford, U.K. Impedance measurements were performed in the range of 100 kHz to 10 mHz with a 5 mV amplitude AC sine wave on a Voltalab PGZ402 model potentiostat in order to evaluate and compare the impedance responses of the materials. Before running any EIS measurements, cells were rested for several hours to stabilize the voltage responses. The same instrument was used for cyclic voltammetry (CV) experiments with the electrode materials at a sweep rate of 100 mV s1 at room temperature. XAS measurements were performed at beam lines X-3A and X-18A of the National Synchrotron Light Source at Brookhaven National Laboratory located in New York. Electrodes from the Li coin cells, cycled at low rates (C/20), were rinsed with DMC and extracted, then sealed with Kapton tape and stored in glass vials, were taped with Teflon tape, and packed in moisture impermeable aluminized bags under argon to avoid any possible oxidation during transportation to the light source. The data were processed using the Athena software program (B. Ravel and M. Newville, J. Synchrotron Radiat., 2005, 12, 537-541). Scans were calibrated, aligned and normalized. DC conductivity measurements were determined using pellets of the pristine materials. Special precaution was given to the pellet preparations of each material such that they had identical pellet densities. Details of the experimental setup and conductivity calculations can be found in a previous publication (M. N. Ates, et al., J. Electrochem. Soc., 2014, 161, A290-A301). The surface area and porosity properties of the material were determined using the Brunauer-Emmett-Teller (BET, Quantachrome Nova) method using nitrogen as adsorption gas. Lithium anode-containing coin cells were fabricated for evaluating the MNC cathode electrochemistry. The cathode was prepared from a mixture of 80 wt % (weight-percent) of the MNC cathode material, 10 wt % Super P carbon black as electronic conductor and 10 wt % polyvinylidene fluoride (PVDF-Kynar® 2801) as binder. The cathode mixture was dissolved in N-methyl 2-pyrrolidone (NMP, Sigma Aldrich >99%) and the resulting slurry was coated onto an aluminum foil current collector using a doctor-blade technique. The cathode ribbon thus obtained was dried at 100 C in vacuum. Coin cells were built with discs of this cathode and Li foil anode, separated by a porous propylene membrane separator, and filled with 1 M LiPF6/1:1.2 EC/DMC electrolyte. The cells were cycled between 2 and 4.9 V at room temperature with an Arbin Instrument BTZ2000 model cycler at a series of discharge currents and their corresponding C rates are mentioned in data figures presented throughout the paper. Theoretical capacity of the materials was calculated to be 280 mAh/g based on one Li utilization per MO₂ formula.

### Example 3

### Electrochemical Performance of 0.5Li₂MnO₃-0.5LiMn_{0.5}Ni_{0.35}Co_{0.15}O₂ in Li Cells

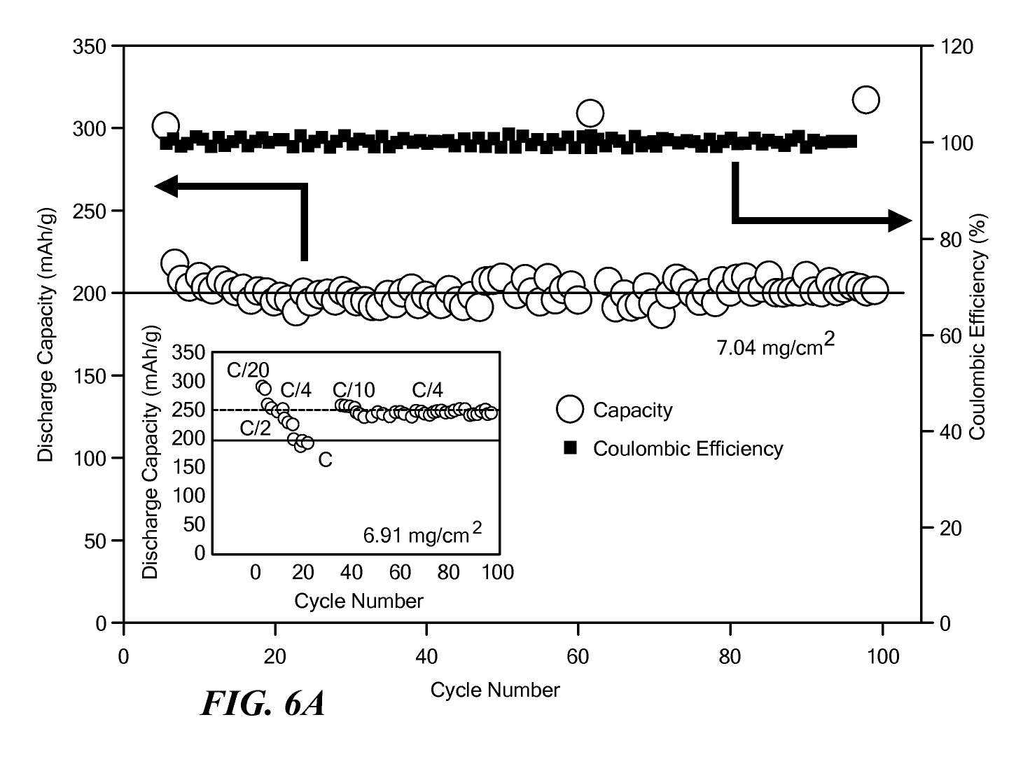

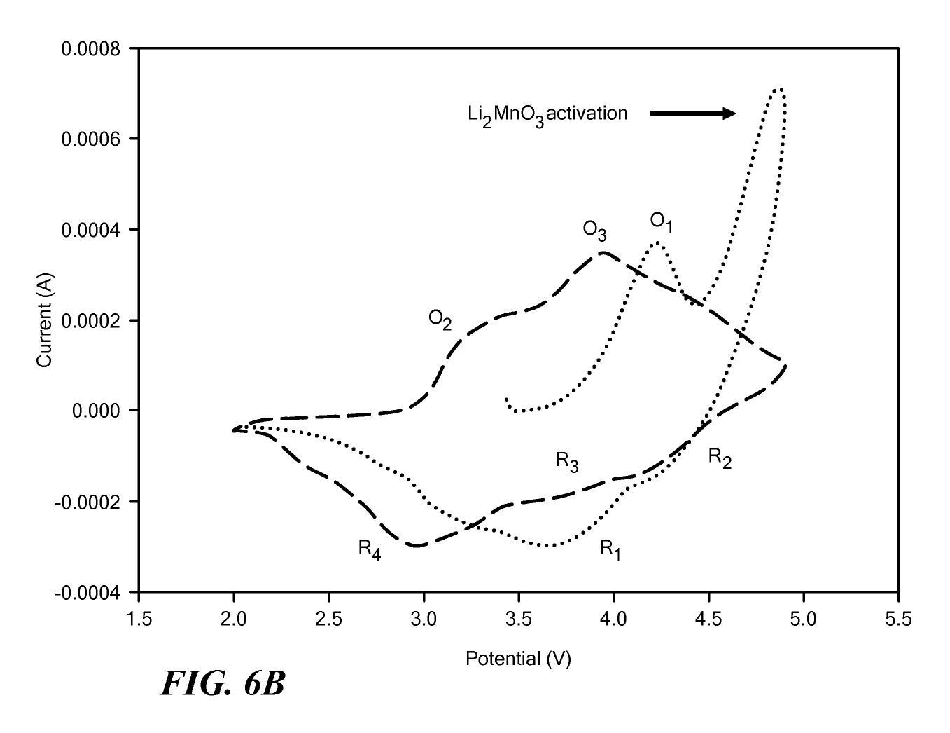

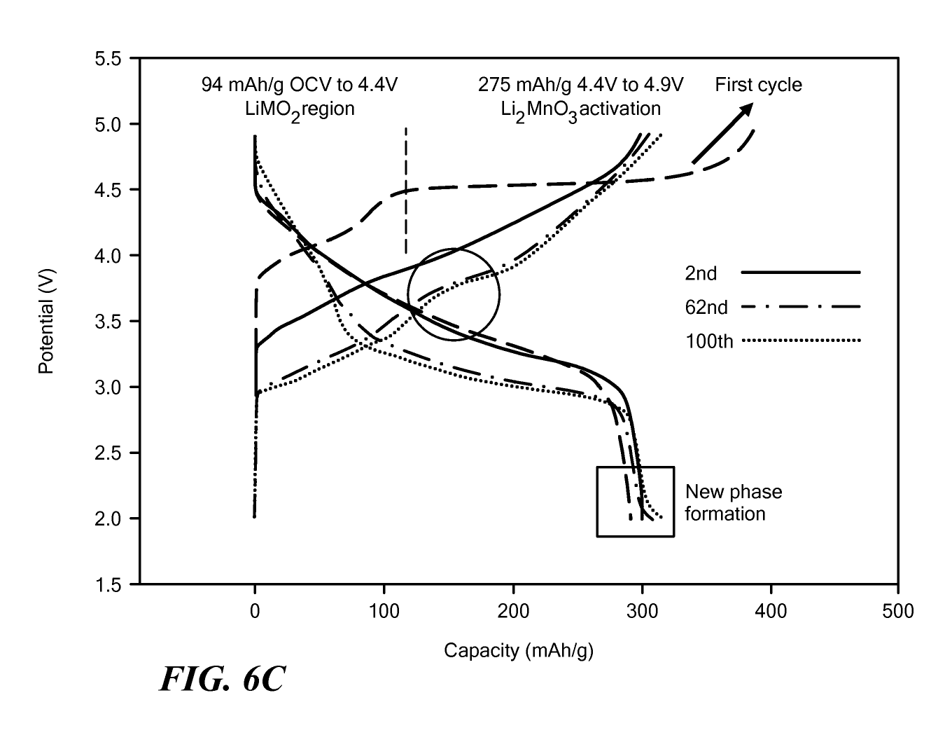

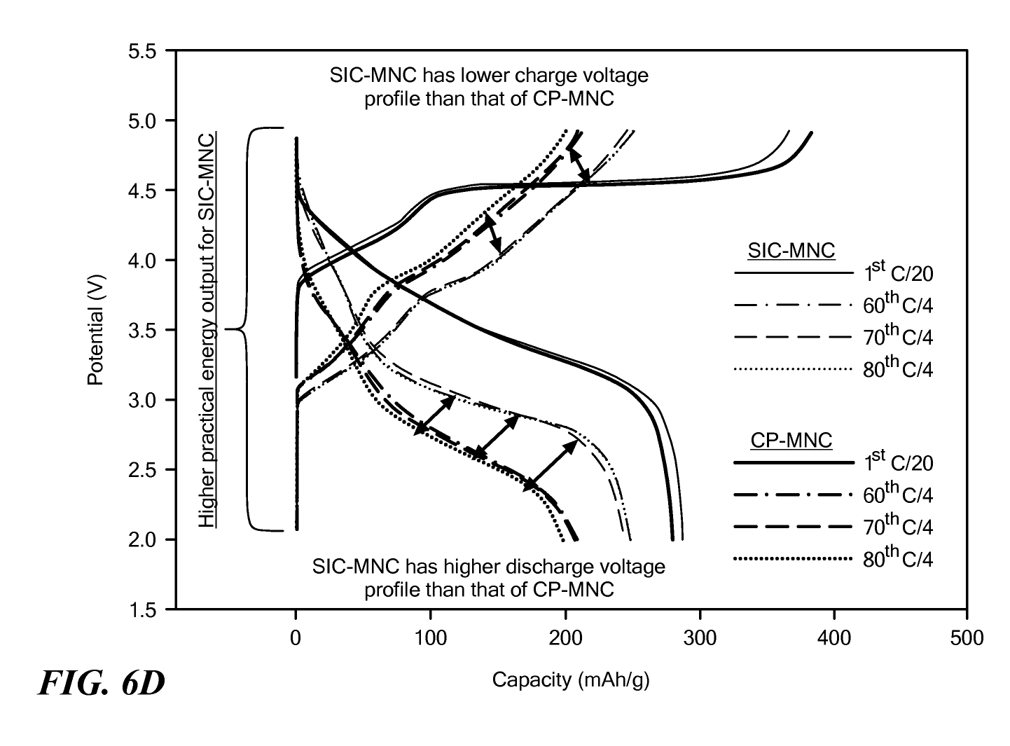

The electrochemical behavior of the SIC-MNC cathode, and its outstanding cycling stability at 1C and other discharge rates are depicted in FIG. 6A. The initial discharge capacity at C-rate was around 220 mAh/g which after a few cycles stabilized at around 200 mAh/g and maintained this value even after 100 cycles with excellent columbic efficiency. The capacity fade rate between the 10th and the 100th cycle is less than 0.01% which for this type of materials is unprecedented. At this fade rate the cathode will lose less than 10% of its capacity after 1000 cycles. Even a 20% loss of capacity after 1000 cycles is exceptional for this family of next generation cathode materials. The material demonstrated impressive capacity retention of >99% at C/4 with a capacity of about 250 mAh/g after 90 cycles (see the inset of FIG. 6A which also shows capacities at different rates). Contrasting this performance is the recent report for a material of similar composition, but prepared by the conventional co-precipitation method (X. Yu, et al., Adv. Energy Mater., 2014, 4, 1-11, DOI: 10.1002/aenm.201300950), of a capacity of only 248 mAh/g after 75 cycles at 21 mA/g (C/10) rate, albeit a decent cycling stability. That publication did not report any cycling data at the C rate. SIC-MNC of the present invention exhibited 281 mAh/g after 75 cycles at the higher current density of 28 mA/g. In the class of Li-rich “layered-layered” cathode materials, the present SIC-NMC demonstrated higher rate and better cycling abilities at both low and high discharge rates than any material reported and known to the inventors. See F. Cheng, et al., J. Mater. Chem. A, 2013, 1, 5301-5308; M. Gu, et al., ACS Nano, 2012, 7, 760-767; W. He, et al., J. Mater. Chem. A, 2013, 1, 11397-11403; J. Liu, et al., J. Mater. Chem., 2012, 22, 25380-25387; S. Guo, et al., J. Mater. Chem. A, 2014, 2, 4422-4428; and C.-H. Shen, et al., ACS Appl. Mater. Interfaces, 2014, 6, 5516-5524.

The high rate capability and exceptional capacity retention of the present SIC-MNC material with repeated discharge-charge cycling are attributed to the porous morphology and high electronic conductivity. The new SIC-MNC material was compared with the extensively studied CP-MNC materials in their rate and cycling performances. FIG. S1\ shows the typical capacity fade during cycling and the poor rate capabilities of the CP-MNC material which clearly contrasts with the behavior of the new SIC-NMC presented in FIG. 6A.

The redox behavior of SIC-MNC was further investigated by cyclic voltammetry displayed in FIG. 6B. During the first charging process (1st chg), two dominant peaks appeared at around 4.2 V and above 4.5 V. The first peak, denoted as O1, can be ascribed to the oxidation of Ni²⁺ and Co³⁺ to Ni⁴⁺ and Co⁴⁺, respectively. The second peak above 4.5 V is due to Li₂MnO₃ activation where Li₂O is released from the structure. During the subsequent first discharge (1st dchg), the reduction peak appearing around 3.6 V could be associated with Co⁴⁺ and Ni⁴⁺ reduction. After the activation of Li₂MnO₃, some new redox features were observed in the second cycle. For example, during the second charge, peak O₂, appeared. This peak is probably due to the oxidation of reduced (lithiated) MnO₂ (from Mn³⁺ to Mn⁴⁺) created in the first discharge. Subsequently, peak O3 appeared due mainly to Ni²⁺/Ni⁴⁺ oxidation and a small peak just below 4.5 V was found which is ascribed to the oxidation of Co³⁺. These oxidation peaks are followed by reduction peaks R2 and R3 which could be Co⁴⁺ and Ni⁴⁺ reduction, respectively (C.-H. Shen, et al., ACS Appl. Mater. Interfaces, 2014, 6, 5516-5524). Finally, peak R4 due to Mn reduction from partially oxidized Mn³⁺ appeared.

In general, after the first cycle the peaks shifted to lower potentials, a strong indication of structural transformation. FIG. 6C shows the voltage versus capacity profile for the high rate cycling data presented in FIG. 6A. Several interesting features were observed; the first feature is the plateau region during the first charging process after 4.3 V, attributed to Li₂MnO₃ activation where the ICL of 70 mAh/g originates. The charging in the second and subsequent cycles begin at lower voltages with upward sloping voltage profiles which are a clear indication of structural rearrangements as a result of the activation process in the first charge. Most importantly, the capacity attained in the second cycle was preserved after 100 cycles. A small plateau appeared at around 2 V region in later discharges, displayed with a box in FIG. 6C, suggesting a new phase formation with repeated cycling, most likely the spinel phase. The spinel peak associated with Mn reduction usually starting at 2.7 V but gradually moving to lower than 2.3 V24,29 augur well with this view. It is possible that such a phase transition at low rates can be inhibited by limiting the discharge voltage to about 2.5 V as no capacity contribution was observed under 2.5 V. Secondly, the voltage fade seen in FIG. 6C is a common problem encountered in Li rich layered cathode materials as a consequence of metal migration after several initial cycles following the Li₂MnO₃ activation. FIG. 6D shows the charge-discharge voltage profiles for each material with respect to their applied rate. It is readily seen from this figure that the cell utilizing SIC-MNC cathode mitigated the voltage fade which from the practical point of view will improve the overall specifc energy of the Li-ion cell.

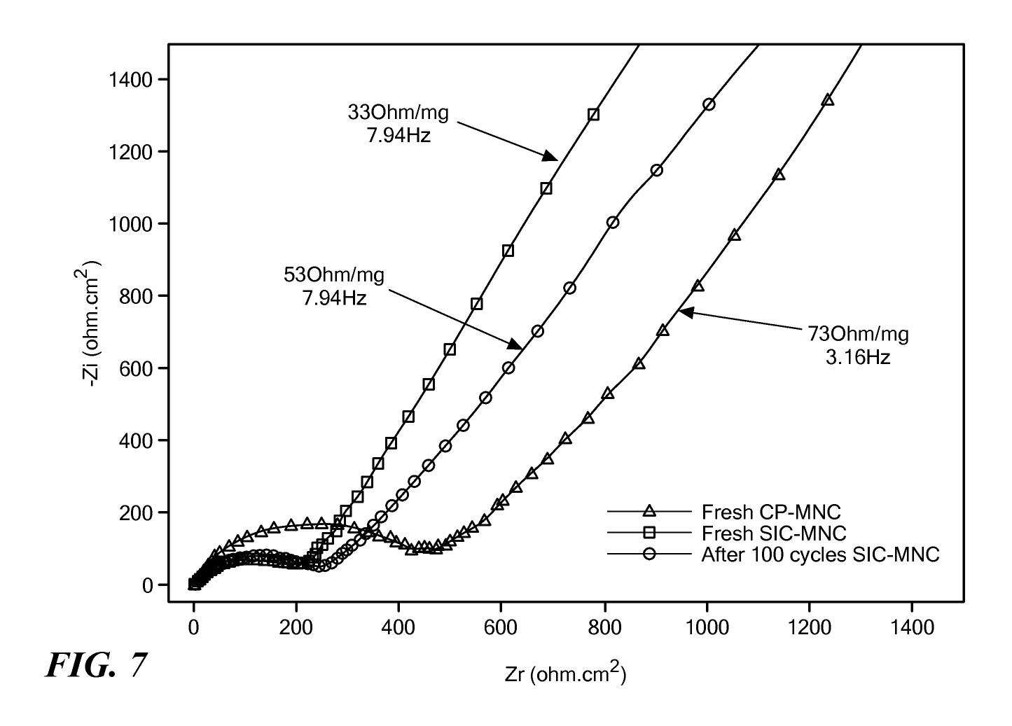

DC conductivity measurements of SIC-MNC and CP-MNC were determined using I-V curves plotted from galvanostatic excitation current data of pressed pellets as reported previously for another material (M. N. Ates, et al., J. Electrochem. Soc., 2014, 161, A290-A301). It is known that conventional Li rich MNC materials suffer from low electronic conductivity (S. K. Martha, et al., J. Mater. Chem. A, 2013, 1, 5587-5595). In contrast, a higher electronic conductivity of 9×10⁻⁶ S/cm at 22 C was measured for the SIC-MNC than for the CP-MNC of 2×10⁻⁸ S/cm, which partially accounts for the excellent rate capabilities of the SIC-MNC. Complementing electronic conductivity EIS data showed that the SIC-MNC electrode has significantly lower impedance at open circuit voltage (OCP) than the CP-MNC electrode (see FIG. 7). Normalized resistances were calculated to be 33 Ohm/mg for the SIC-MNC electrode while it was found to be 73 Ohm/mg for the CP-MNC electrode of identical loadings. As displayed in FIG. 7, the EIS was also measured after 100 cycles for the cell utilizing SIC-MNC cathode, and the measured resistance of the cell (53 Ohm/mg) was smaller than that of the fresh cell containing CP-MNC cathode. Plausible arguments to support this improvement are provided below from the FESEM data. These resistances are primarily a measure of charge transfer resistance (Rct), related to Li⁺ diffusion/migration through and/or at the surface of the electrode particles which is lower in the new material accounting for its higher rate capability.

### Example 4

### Structure-Property Considerations of 0.5Li₂MnO₃-0.5LiMn_{0.5}Ni_{0.35}Co_{0.15}O₂

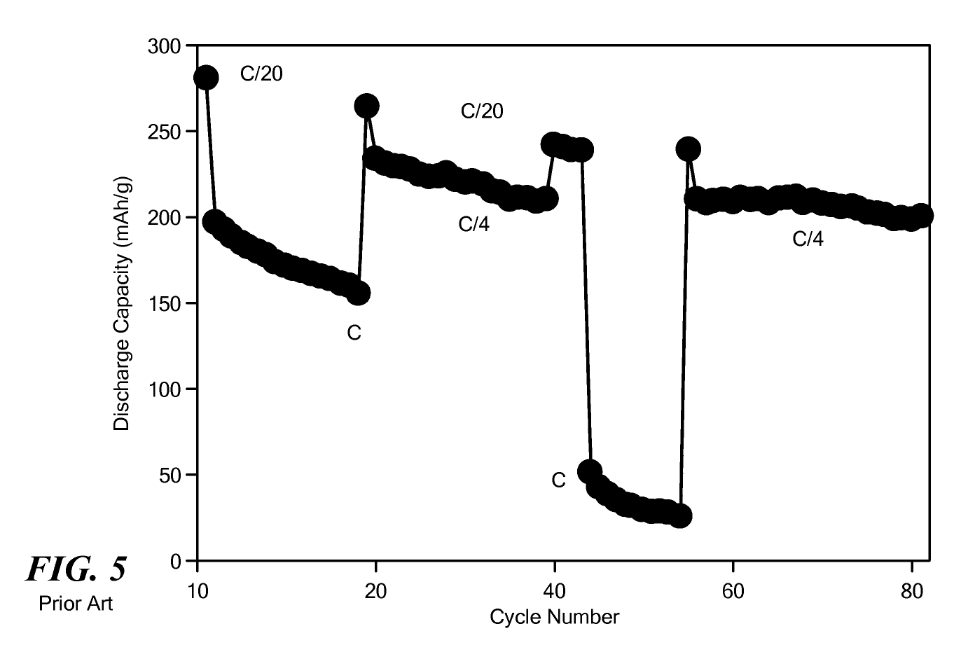

Correlations of the observed electrochemical properties of SIC-NMC with its crystal structure were established through XRD, FESEM, HRTEM and XAS studies. FIG. 1 illustrates SIC-MNC material preparation procedure. The FESEM figure displayed in FIG. 1 represents the sponge-like metal oxide intermediate product obtained from the self-ignition combustion reaction. This highly porous structure appears to play a vital role in enhancing the rate capability of the cathode material. The surface areas and pore sizes of the as-synthesized SIC-MNC and CP-MNC were determined in order to gain further insight into their morphologies. Surface areas of 3.72 m²/g for SIC-MNC and 5.56 m²/g for CP-MNC were obtained. Surprisingly despite its open pore structure, the surface area of SIC-NMC is lower than that of CP-NMC. The average pore-size of the SIC-MNC was determined to be 164 A, while it was found to be 89 A for the CP-MNC, both characterized as pristine materials. While larger pores scattered in the SIC-NMC crystals promote electrolyte penetration, its lower surface area appears to decrease side reactions with the electrolyte. This suggests that the higher surface area of CP-MNC may be promoting more side reactions than the new SIC-NMC. In other words SIC-NMC is a more stable cathode material. These results bode well with the superior electrochemical performance of SIC-MNC presented in FIG. 6A than the one displayed in FIG. 5 for CP-MNC. These internal micropore structures shown in FIG. 1 were, to some extent, maintained after the heat treatment as well thereby creating voids at/through the surface of the cathode particles in order for electrolyte to access and improve Li⁺ transport effectively leading to higher discharge rates. Furthermore, the void spaces are probably effective buffer zones against crystal volume changes.

### Example 5

### Morphological Observations Through FESEM and HRTEM

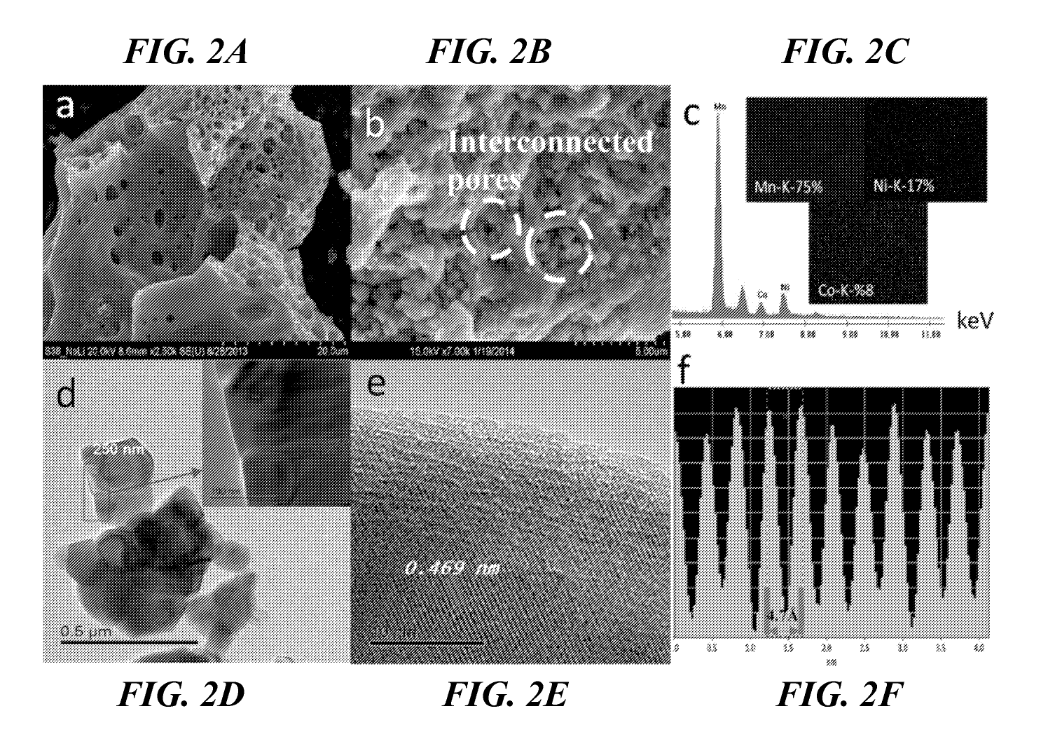

FIGS. 2A-F depict detailed FESEM images coupled with EDS mapping analysis, and HRTEM observations together with cross-sectional profile to measure the lattice fringes. FIG. 2A shows a typical combustion metal oxide product having highly open pores with sponge-like feature. Interconnected micropore structures were partially retained after Li precursor addition followed by high temperature calcination as can be observed in FIG. 2B, marked with dashed oval shapes. During cycling, particularly at high discharge rates, these structures appear to enable effective electrolyte penetration through and/or at the cathode particle surface yielding maximum discharge capacity. Besides their similar particle size of around 200-300 nm, elemental analysis confirmed that both materials have the targeted transition metal compositions determined from EDS. Elemental mapping and EDS spectrum of SIC-MNC can be seen in FIG. 2C. FIG. 2D demonstrates HRTEM bright-field image of the pristine SIC-MNC material with an upper inset of the figure showing where we performed further investigations. This figure shows nanosized particles (approximately 100 nm) which agglomerate to the secondary particles in the range of 200-250 nm. FIG. 2E shows the lattice fringes associated with the (001) and/or (003) planes of the R3m and C2/m phases, respectively, which can be complemented by the XRD results from which we determined such planes having similar interplanar distance at around 4.68 A. The as-generated cross-sectional profile in FIG. 2F proved that each lattice fringe was separated by 4.7 A, an indication of consistent lattice fringes.

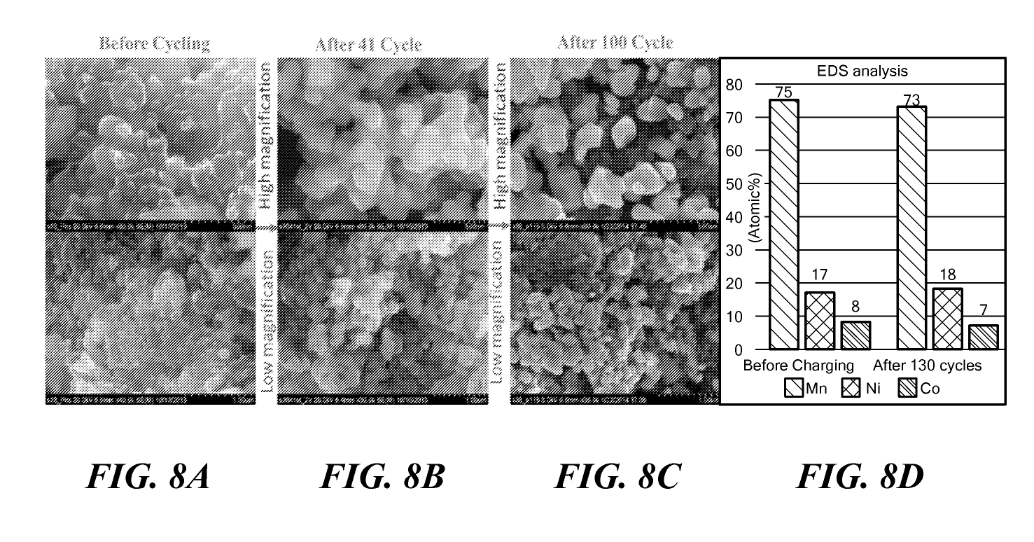

FIGS. 8A-8D display the FESEM images of cycled SIC-MNC cathodes at both high and low magnifications together with EDS analysis. Impedance of a cell and its capacity retention are greatly dependent upon the solid electrolyte interface (SEI) on the electrodes. The SEI thickness changes as cycling continue. Thick SEI layer, which is a consequence of continued reactions between electrode particles and electrolyte during cycling, is probably formed less in SIC-MNC due to interconnected particles which exposes less cathode surface to the electrolyte. This is seen from the FESEM data in FIG. 8C where after 100 cycles, interconnected particles are still seen. From EDS analysis, atomic ratios of each element were found to be little changed. In summary, lower cathode surface area of SIC-MNC is exposed to the electrolyte with an overall lower extent of reaction with the electrolyte resulting in excellent capacity retention; i.e. almost 100% capacity after 100 cycles. Structural considerations using X-ray and electron diffractions.

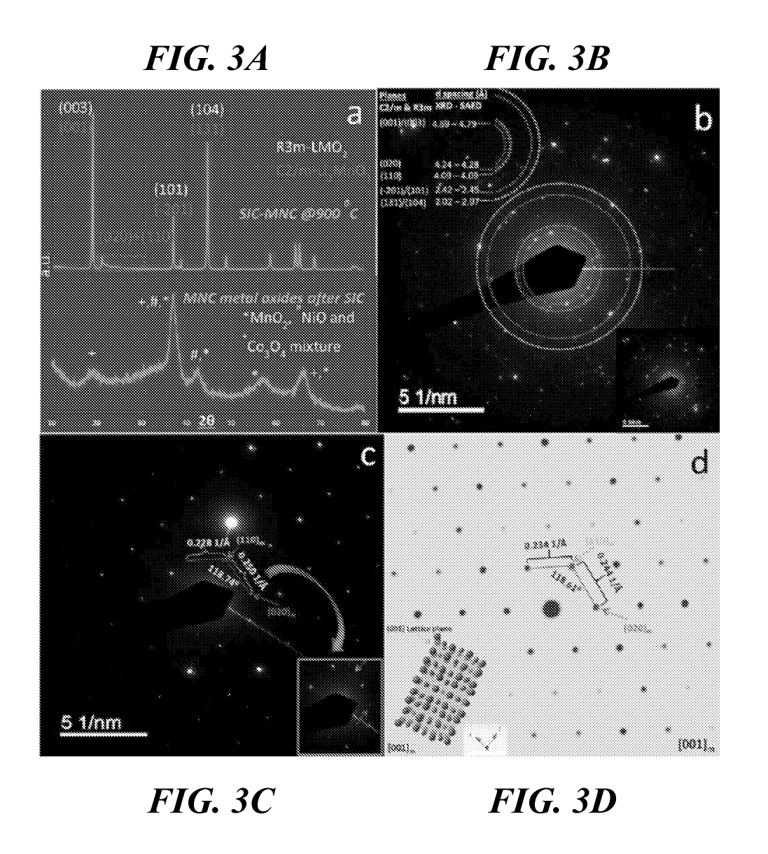

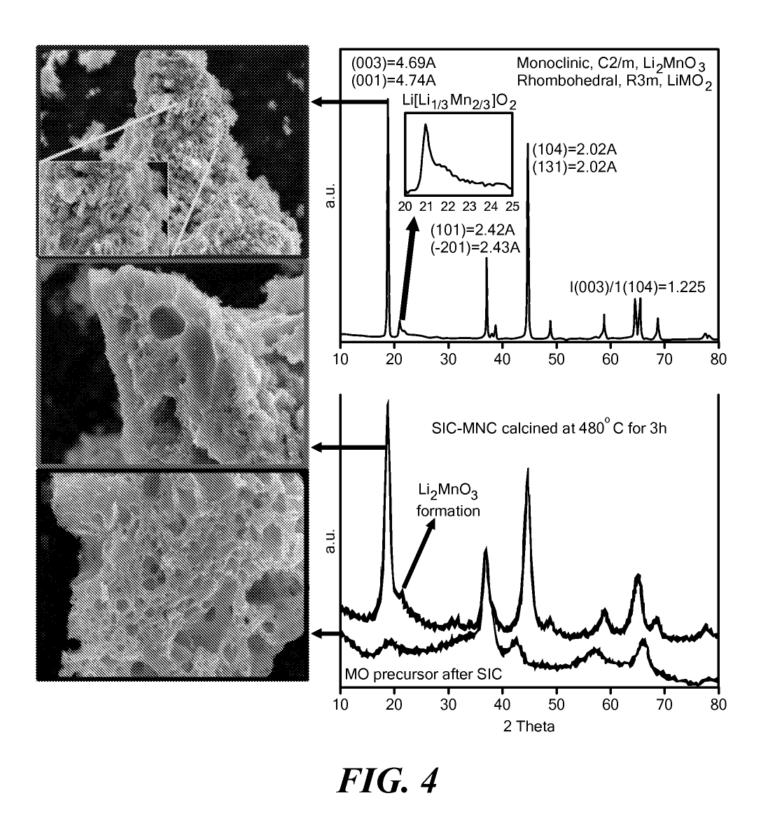

As shown in FIG. 3A, the XRD analysis (the bottom one) revealed that the powders after the self-combustion can be indexed for a mixture of MnO₂, NiO and Co₃O₄ advocating that the intermediate product is a mixture of different metal oxides according to the stoichiometry initially obtained. The detailed XRD evolution with respect to their morphological changes is demonstrated in FIG. 4. The XRD profile of the synthesized pristine SIC-MNC powder after the final heat treatment is displayed at the top of the FIG. 3A, along with indexed dominant planes. Li₂MnO₃ feature, displayed with dashed rectangle, is examined further and found to have intensities similar to the compound CP-MNC synthesized via co-precipitation method. Cation mixing is a common problem amongst layered metal oxides materials which is caused by non-removable Ni²⁺ ions sited in Li layers thereby creating barriers for Li diffusion. This feature can be identified using the ratio of the peak intensities belonging to (003) and (104) reflections; the higher this ratio the better is the layered structure desirable for high rate performance. The I(003)/I(104) ratio for SIC-MNC was found to be 1.23 versus 1.18 for CP-MNC, which further lends support to the higher rate capability of SIC-MNC.

FIG. 3B displays selected area electron diffraction (SAED) pattern which yielded Laue ring-pattern revealing the polycrystalline nature of the material. The first ring affirmed a d-spacing of around 4.7 A which can be perfectly indexed to (003) and/or (001) planes. The subsequent d-spacing values are presented in conjunction with their reflected planes in the inset of FIG. 3B. The calculated d-spacing values were further compared and complemented with the XRD data as displayed in the inset of FIG. 3B.

The weak reflections of Li₂MnO₃ were investigated by increasing the exposure time during the diffraction measurement. Representative SAED patterns of this procedure in FIG. 3C showed that some of the diffraction patterns can be solely indexed to C2/m phase. This figure clearly shows that the periodicity of Li and TM orders are interrupted by the weak reflections associated with the Li existing in TM layer as in the case of Li₂MnO₃. This can be observed in the inset of FIG. 3C where the arrows indicate the weak Li₂MnO₃ reflections. Since all C2/m patterns can perfectly be compatible with R3m patterns even at the atomic level,6 indexing can only reveal the existence of Li₂MnO₃ at this pristine stage. In other words, R3m phase is superimposed by the reflection points from C2/m phase. Because of this paucity rendered by the nature of the material, one can surmise that two phases can coexist yielding a composite structure as evidenced by XRD and electrochemical data.

In order to determine zone axis of the observed SAED pattern and verify which diffraction spots correspond to which planes, the raw Li₂MnO₃ (monoclinic-C2/m space group) SAED patterns were simulated, from which one can easily calculate the angles and atomic distance between planes. The simulated pattern, their plane identification and real-time crystal view are displayed in FIG. 3D which resembles perfectly the observed pattern in FIG. 3C thereby unveiling the zone axis and plane identifications.

### Example 6

### Structure Analysis During Cycling

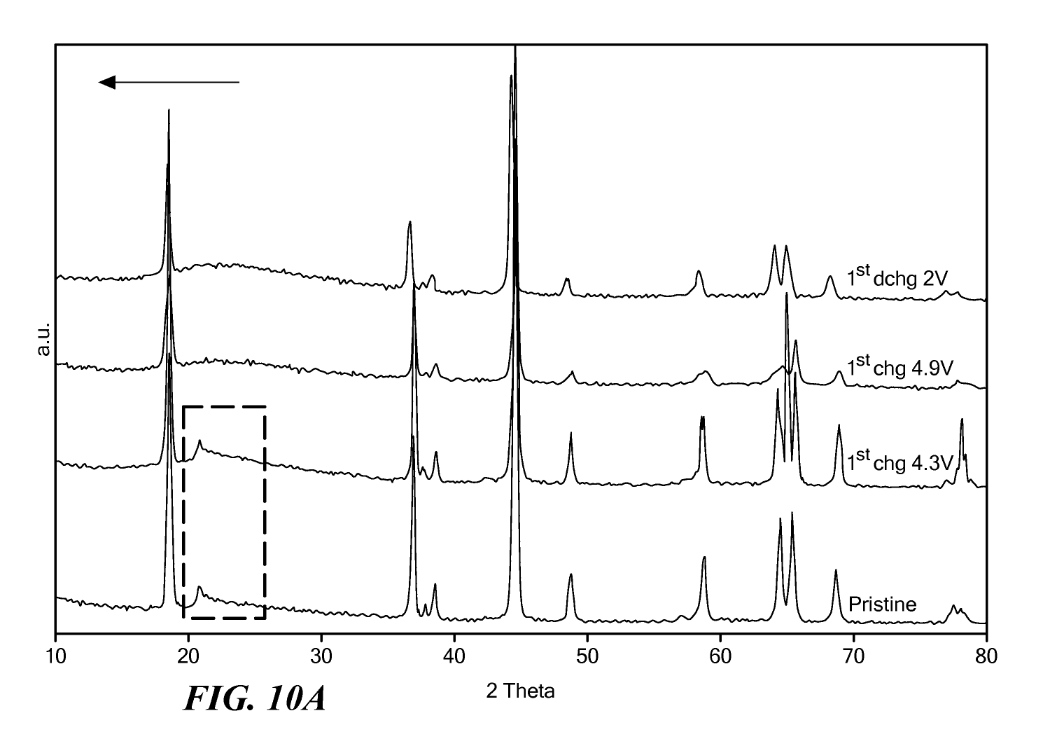

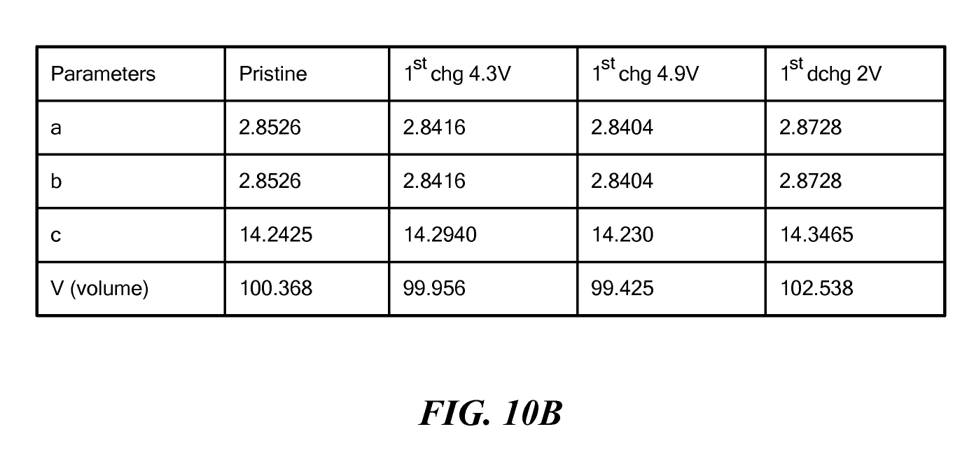

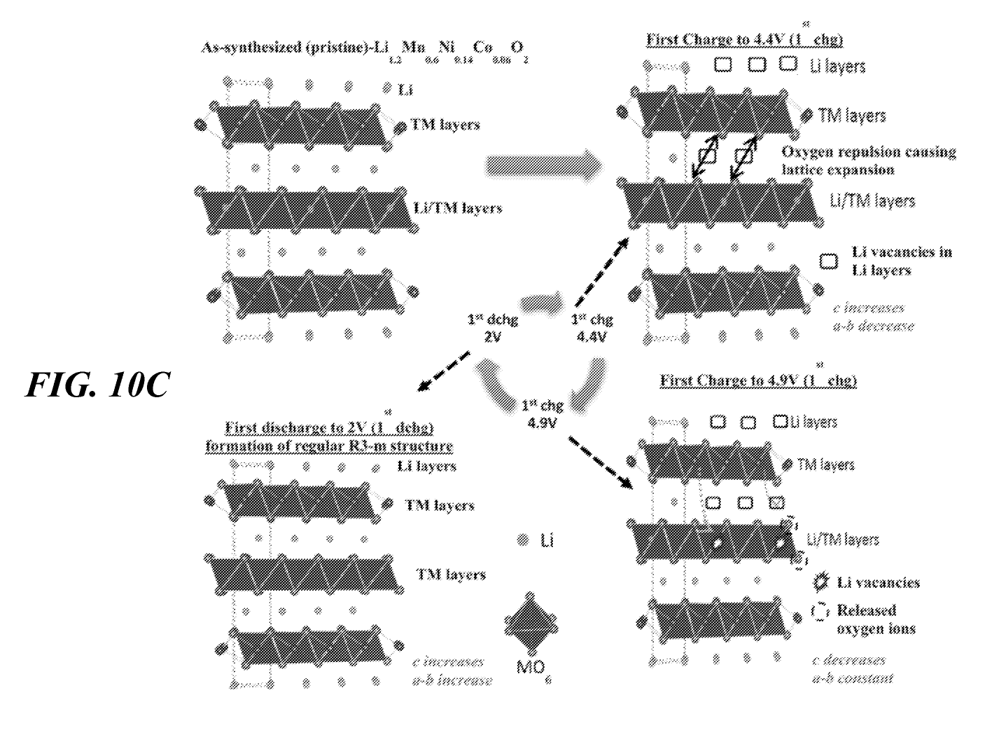

The structural variations were investigated that occur at 4.3 V and 4.9 V during the first charge and at 2 V during the following discharge, using the XRD technique. Each stage is illustrated by means of the expected crystal structure. FIG. 10A displays ex situ XRD profiles and the calculated unit cell parameters are shown in the table in FIG. 10B. They illustrate the crystal structures at the potentials mentioned above. Several compelling points should be made. First and foremost, at the first charging stage to 4.3 V, one can distinguish that the first peak corresponding to (001) rhombohedral and/or (003) monoclinic planes shifted to lower 2q values indicating lattice expansion in the c direction due to higher d spacing. It is reasonable to expect that Li removal causes electrostatic repulsion among oxygen layers which are shielded by Li atoms before the charging process. At 4.3 V, the peaks, marked with dashed rectangle, corresponding to superlattice ordering caused by Li₂MnO₃, did not disappear confirming that the activation process of Li₂MnO₃ does start just after 4.3 V as can be seen in FIG. 6C. The table presented in FIG. 10B further consolidates the fact that c parameter increases after 4.3 V. However, a-b parameters decreases which is obviously due to contraction of metal-metal bond distance induced by oxidation process which yields smaller ionic radii. The complete oxidation of Ni²⁺ (0.69 A) and Co³⁺ (0.61 A) to Ni⁴⁺ (0.48 A) and Co⁴⁺ (0.53 A), respectively, in octahedral coordination environment occurs, and the higher charged states were neutralized by the Li removal during this process. Secondly, charging from 4.3 V until 4.9 V did not significantly change the a-b parameters as can be seen in the table due to the fact that Ni⁴⁺ and Co⁴⁺ ions are not able to be further oxidized. The capacity compensation in this region therefore must be accompanied by irreversible Li₂O removal. Nevertheless, c parameter decreases most likely due to Li removal from the TM layers and metal migration to vacancies created by Li removal ultimately causes crystal shrinkage. This contraction also can be affected by the oxygen release at this high voltage. Releasing oxygen ions from the structure will diminish total electrostatic repulsion thereby the c parameter decreases. The contraction of c parameter at this high potential augur well with the recent publications.22,30 In the case of lithium insertion in the first discharge to 2 V, the a-b parameters increased significantly which suggests that Ni⁴⁺ and Co⁴⁺ were reduced to their initial states where they existed as Ni²⁺ and Co³⁺, respectively. Increasing and decreasing a-b parameters during the first full cycle are a strong evidence of successful Li extraction and insertion process. However, as can be deduced from the table that the a-b parameters are still larger than those before the charging process indicating other TM reduction must occur. Since Ni²⁺ and Co³⁺ cannot be reduced further at this potential, there must be other species that must be reduced. It appears that while Mn ions in Li₂MnO₃ structure were originally spectator ions, after the activation to 4.9 V, the MnO₂ created by the oxidation of Li₂MnO₃ becomes electrochemically active and contributes to the decrease in the a-b parameters. It is concluded that c lattice expansion during discharge to 2 V accompanies Li insertion into MnO₂ and the associated Mn reduction forming the overall Li₁ₓMO₂ layered structure for the composite material as illustrated by unit cell visualization in FIG. 10C.

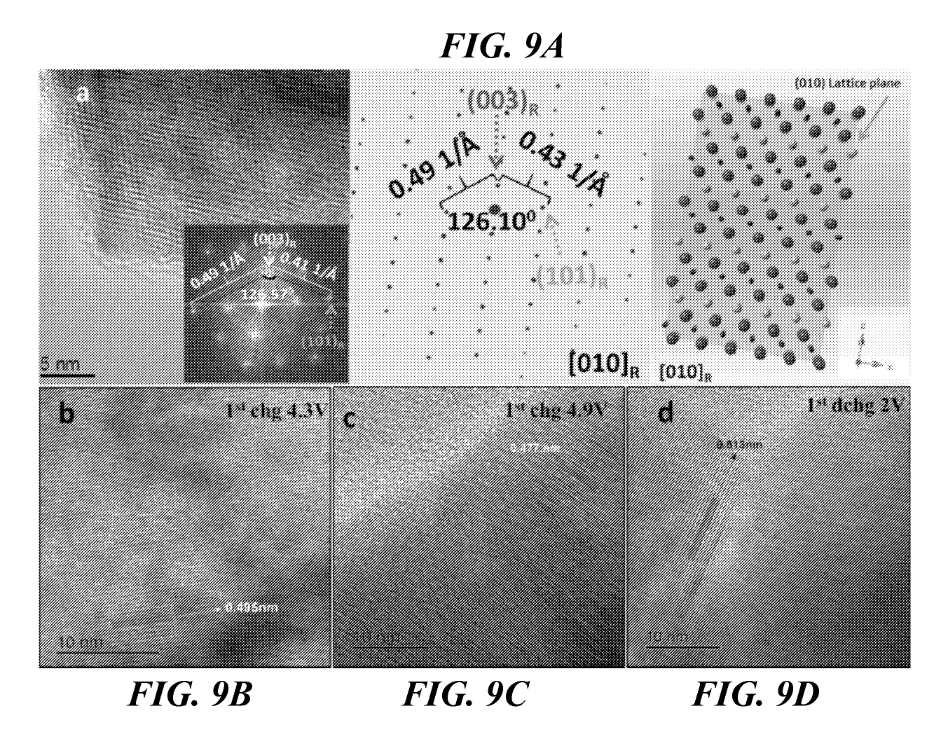

During charging process, it was already determined that, at 4.9 V, the feature of superlattice ordering in Li₂MnO₃ vanished as revealed by XRD results. This can be further complemented by fast Fourier transformed (FT) patterns of an HRTEM image presented in FIG. 9A where no trait of C2/m phases was observed in agreement with XRD results. FIG. 9A also shows simulated SAED pattern of R3m space group along with crystal view in [010] zone axis which perfectly matches with observed SAED spots. Each HRTEM images shown in FIGS. 9B-9D preserved lattice fringes with a significant expansion occurring during the first early charging process (4.3 V). This is due to the strong electrostatic repulsion among oxygen layers as discussed above. At 4.9 V, the lattice fringes showed contraction in the same way observed in the XRD data. The sample discharged to 2 V exhibited lattice expansion again as supported by XRD. However, one should take into consideration that while XRD is a bulk technique, HRTEM images were taken from a single particle which is highly sensitive to atomic level variations. That being said, HRTEM results for each particle may vary but here at least 5-6 different particles were studied, and the average feature is reported. Therefore, the slight discrepancy resulted from (001)/(003) plane or c parameter variations between two methods should be judged and interpreted accordingly.

### Example 7

### X-Ray Absorption Spectroscopy Results

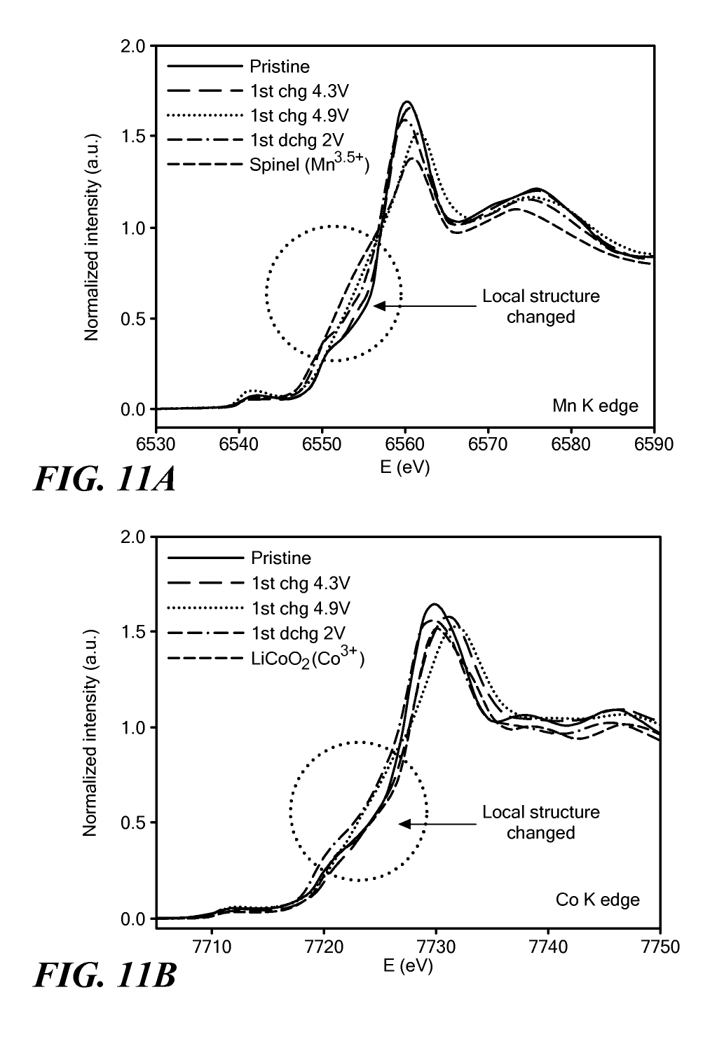

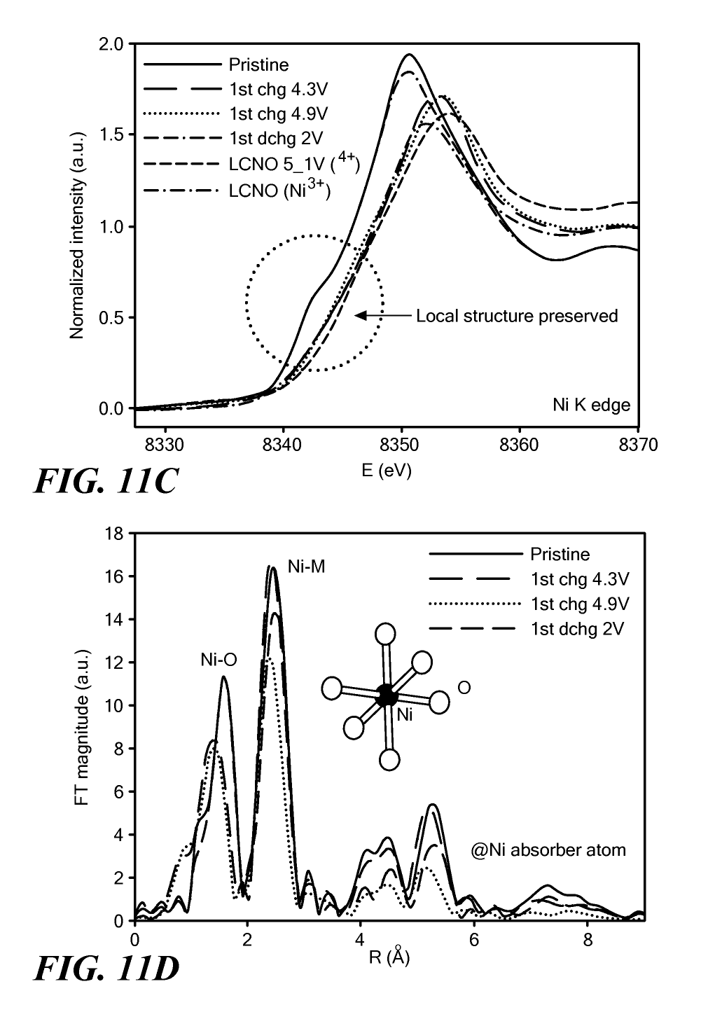

In an attempt to gain more insights into the redox processes and coordination environment of the transition metal, XAS studies of SIC-MNC were performed during the first cycle. FIGS. 11A-11D represent XAS analysis of Mn, Co and Ni—K edges. In principle, the shape of the X-ray absorption near edge structure (XANES) K edge is a useful tool to fingerprint the local coordination environment, whereas the “white line” (threshold energy level) pertains to the valance state of an absorber atom.

FIG. 11A displays Mn—K edge data collected during the first cycle along with a spinel Li₂MnO₄ as reference for Mn 3.5+. As it can be deduced from FIG. 11A, the pristine material's Mn has similar valance state as that of the spinel material. At 4.3 V the valance state of Mn slightly shifted to higher state, evidenced by higher energy values, but the major shift appeared after 4.3 V which further supports that the activation of Li₂MnO₃ commences after 4.3 V, at the long voltage plateau region. After the first discharge, Mn oxidation state was successfully restored to around 3.5+ suggesting that Mn redox process transits between 3.5+ and 4+. The XANES shapes of the pristine and discharged sample (1st dchg-2 V) at Mn—K edge does not match completely which suggests that Mn coordination environment was partially changed. This is true if one considers the activation process of Li₂MnO₃ yielding MnO₂ which does not exist in the pristine material. FIG. 11B shows the Co—K edge where major shifts to higher energy (eV) occurs at 4.3 V but only slightly thereafter at 4.9 V. The additional oxidation reaction of Co most likely takes place before 4.4 V since after this potential Li₂O removal accompanies oxidation reaction as can be seen in CV in FIG. 6B. A recent report (X. Yu, et al., Adv. Energy Mater., 2014, 4, 1-11, DOI: 10.1002/aenm.201300950) suggested that at 4.4 V, minimal energy shifts observed for Co—K edge indicating that further Co oxidation might have taken place in the 4.3-4.4 V region in the present sample forming coalesced oxidation peak at around 4.4 V as can be deduced from FIG. 6B. The shape of Co—K edge also deteriorated and was not restored after the first discharge, advocating that Co local structure was changed in addition to Mn.

Nevertheless, Ni—K edge data unraveled some interesting results in contrast to Mn and Co—K edges. First of all, Ni oxidation to Ni⁴⁺ fully occurs before 4.3 V except for the very slight energy shift to a higher value observed at 4.9 V in FIG. 11 C. This suggests Ni and Co species are the only oxidized transition metals during the first charge at 4.3 V. After this potential, slight oxidation reactions of Mn took place which did not affect the a-b parameters. Overall a-b parameters remain almost constant between 4.3 V and 4.9 V during the first charging process as discussed in the XRD section. The reduction process of Ni was complete during discharge to 2 V and the overall XANES profile was not affected at all, advocating the local structure of Ni was preserved, at least in this composition. Furthermore, Fourier transform extended X-ray absorption fine structure (EXAFS) analysis of Ni—K edge is displayed in FIG. 11D along with a metal surrounded by six oxygen framework to show the first shell. The first peak centered at around 1.5 A corresponds to Ni—O first shell coordination and the second peak at around 2.5 A is ascribed to Ni-M (M ¼ Ni, Mn and Co) scatterings. In the pristine material Ni—O bond distance is calculated to be around 1.59 A but at both 4.3 V and 4.9 V Ni—O bond distance decreased dramatically to a value of approximately 1.42 A. In conjunction with XANES and XRD, this further proves Ni oxidation mostly occurs before 4.3 V indicating a critical cutoff potential during the first charge. After the first discharge, Ni—O reaches its initial bond distance without any change. From these results, it was found that local structures of Mn and Co metals are sensitive to the first cycle as opposed to Ni atom.

### Example 8

### Extended Cycling of SIC-MNC Cathode

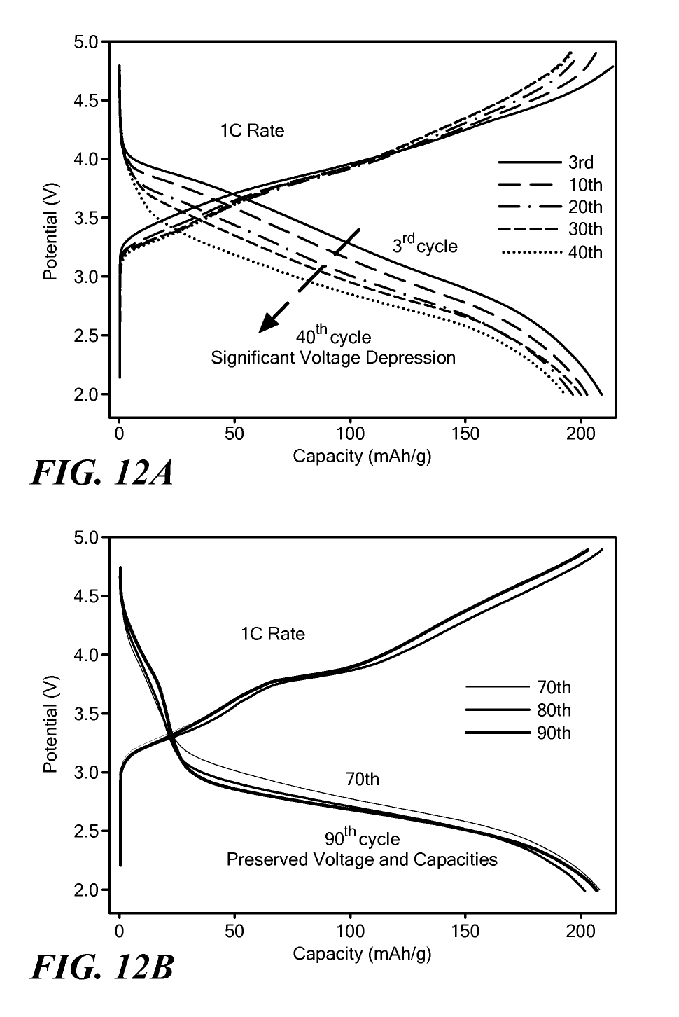

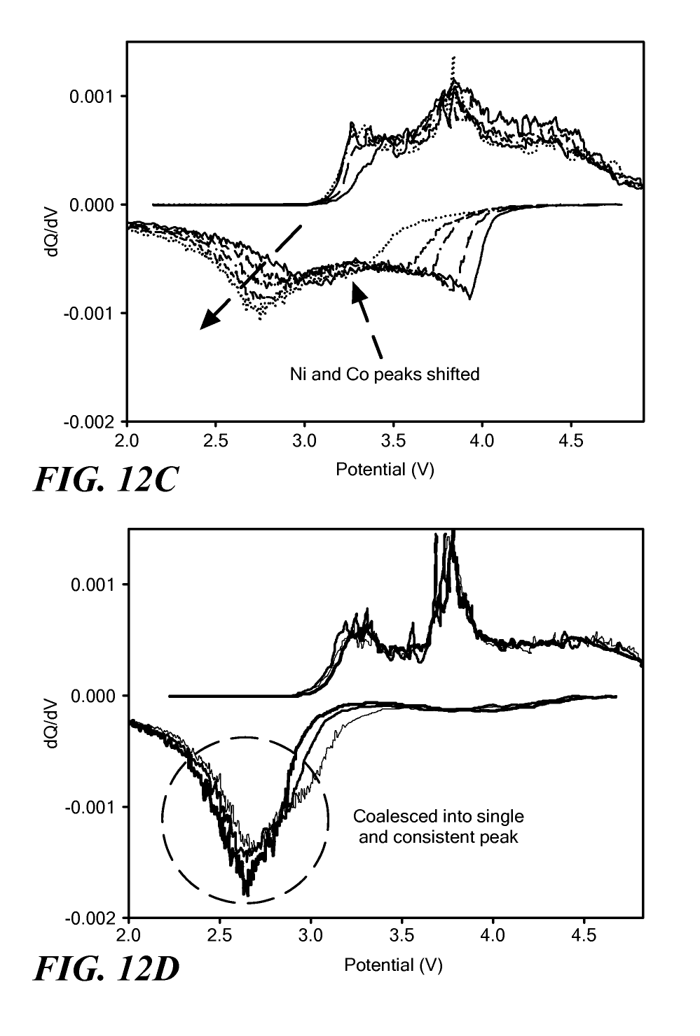

Ex situ XRD, XAS and HRTEM studies were performed for SIC-MNC cathodes in order to determine the origin of phase transformations after long-term cycling. FIGS. 12A-12D display charge-discharge voltage versus capacity profiles and the corresponding dQ/dV plots of the cell utilizing SIC-MNC cathode at 1C discharge rate at room temperature. From FIGS. 12A and 12B, one can easily observe that the major voltage decay takes place during early cycles going from the 1st to 50th cycle. After that the discharge profiles are stabilized as displayed in FIG. 12B. This is further seen from their differential capacity plots given in FIGS. 12C and 12D. In FIG. 12C, the reduction peak corresponding to Ni and Co metals is shifting towards the Mn peak which is believed to be the main cause of the voltage hysteresis seen in FIG. 12A. After these structural rearrangements the reduction peaks of all metals coalesce into a single dQ/dV peak as can be seen in FIG. 12D. This behavior yields the steady discharge voltage profiles versus constant capacity values displayed in FIG. 12B.

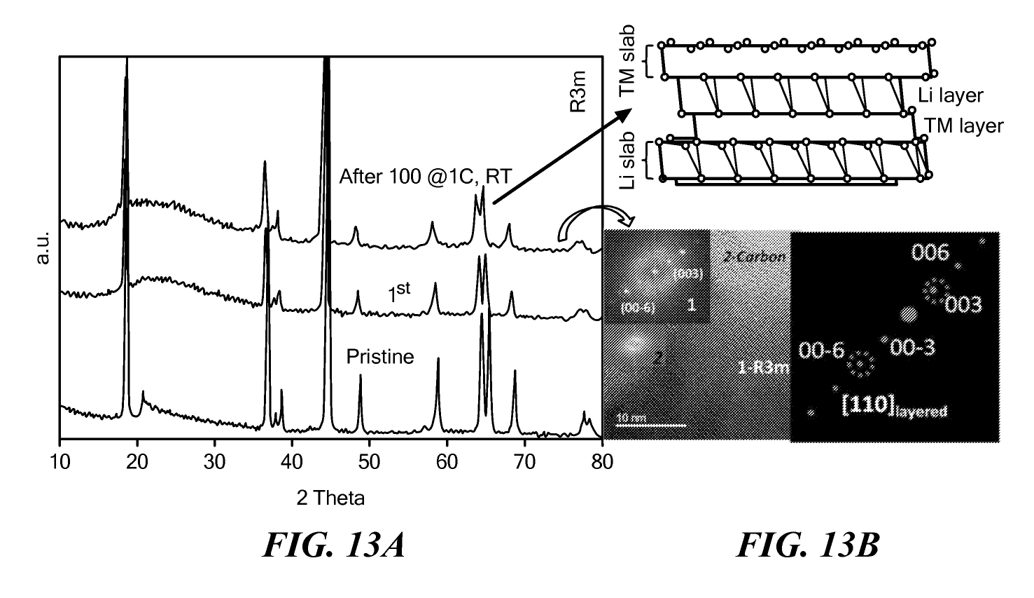

To understand whether or not these metal migrations and voltage decay are reflected in the XRD patterns, the XRD patterns of SIC-MNC cathode were measured after 100 cycles at the 1C discharge rate. FIG. 13A shows the ex situ XRD patterns of three samples, the pristine SIC-MNC, the electrode after the first discharge, and after 100 cycles discharged to 2 V. Interestingly, no strong evidence was found for any phase change as evidenced by the absence of the spinel phase in these samples. Several points should be noted; firstly the doublet peak located at around 652q, a direct indication of perfect layered structure, was preserved after 100 cycles. Nevertheless, the ratio of the intensity of the two doublet peaks, which was approximately 1 before cycling and after the first discharge at 2 V, started to change which may be a sign of small phase transition. In addition, the volume of the crystal lattice remained almost the same as after the first discharge suggesting a robust structure was attained. This can be further explained by considering the void spaces in the crystal grains mentioned earlier in this paper which might play a key role against volume changes within the crystal framework. In an attempt to provide further support to the XRD results, the bulk technique, HRTEM was performed. FIG. 13B displays the HRTEM data after 100 cycles at the 1C rate and its corresponding FT patterns are embedded in the figure. Supported by the simulation of R3m phase, located on the right side of HRTEM figure, FT pattern of the cycled SICMNC revealed that the crystal maintained its layered feature. It should be noted that in the HRTEM experiments, several other segments of the cathode were run, but none of the acquired data revealed spinel-like feature.

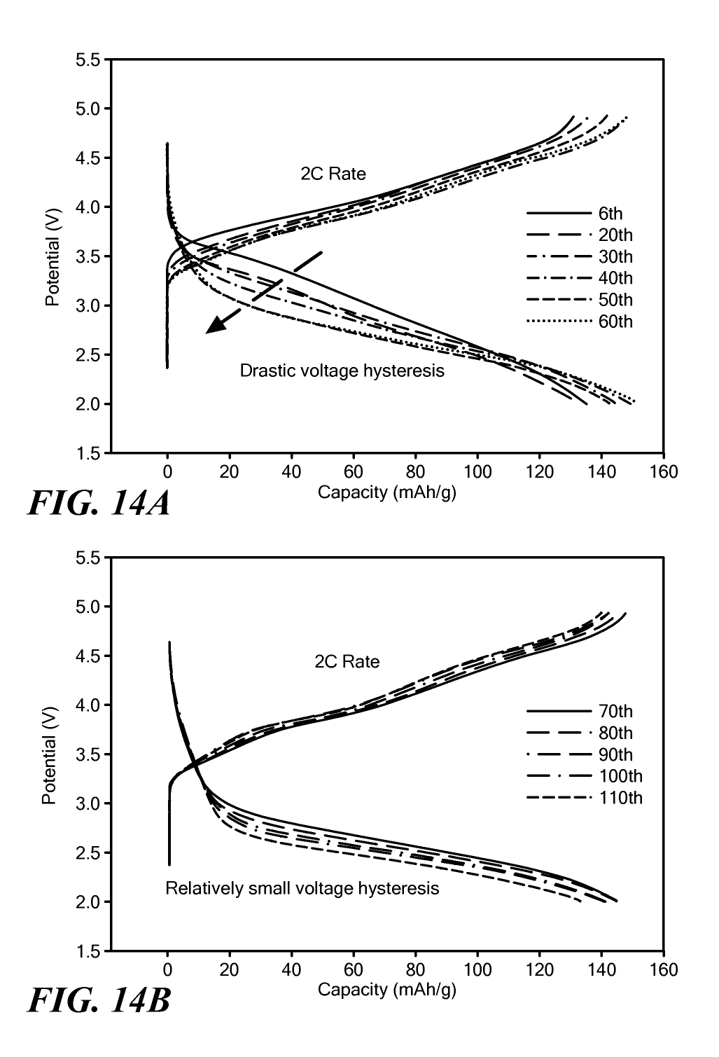

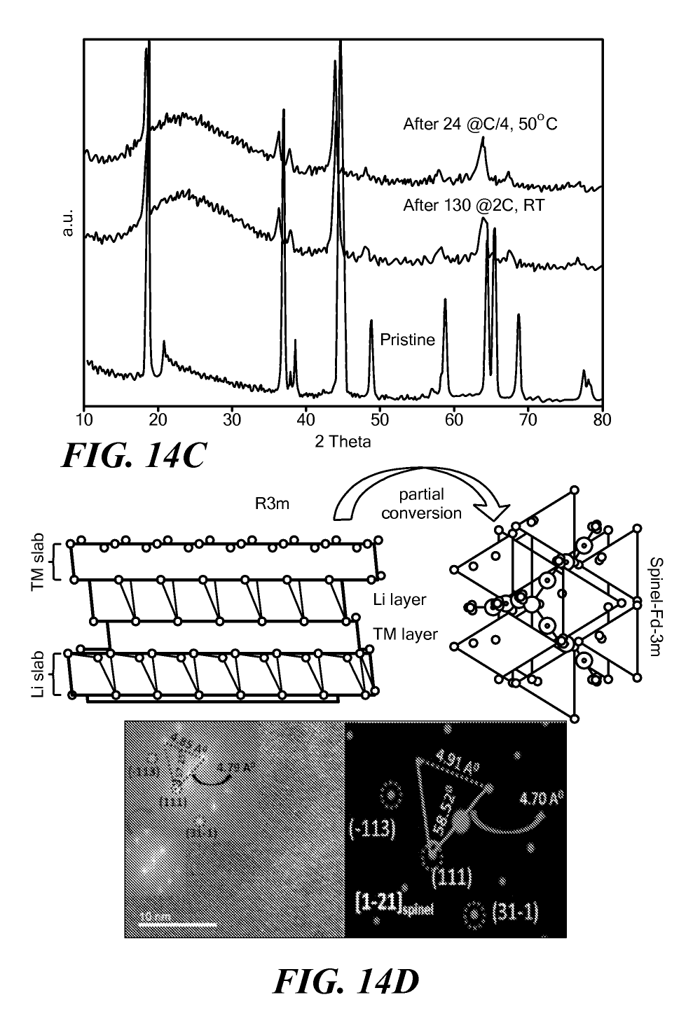

To understand rate and high temperature cycling effects on crystal structure and voltage fade phenomena, ex situ XRD and HRTEM were performed on two samples, (i) after 130 cycles at 2C discharge rate at ambient temperature, and (ii) after 24 cycles at C/4 discharge rate at 50 C. Contrasting to what was observed after 100 cycles at 1C discharge rate, structural transformation was identified, as evidenced by XRD and HRTEM data. FIGS. 8a and b display charge-discharge profiles of the SICMNC containing cell at the 2C discharge rate which show similar behavior as in FIGS. 12A and 12B where voltage depression occurred in the early 50 cycles. This similarity suggests that voltage hysteresis commences irrespective of structural transformation. In fact, the high temperature cycling test results exhibited very low voltage fade after 20 cycles again advocating that voltage fade does not directly result from and/or contribute to the phase transition. The cycling behavior and charge-discharge profile of high temperature test results are plotted in FIG. 16. From FIG. 14C one can easily surmise that both materials, one run at high temperature and the other at high rates, showed similar XRD patterns that can be indexed to a spinel phase. The doublet peak located at around 65q was converted into a singular peak ascribed to the spinel phase. This was further confirmed and supported by HRTEM figures, shown in FIG. 14D, where FT patterns of the SIC-MNC cathode after 130 cycles at the 2C rate revealed spinel character similar to simulated patterns based on LiMn₂O₄ material. Although this spinel feature was not observed throughout the sample, it can be concluded that partial phase conversion occurs at harsh conditions, i.e., at high temperature and high rate. The crystal lattice changes are visualized in FIG. 14D.

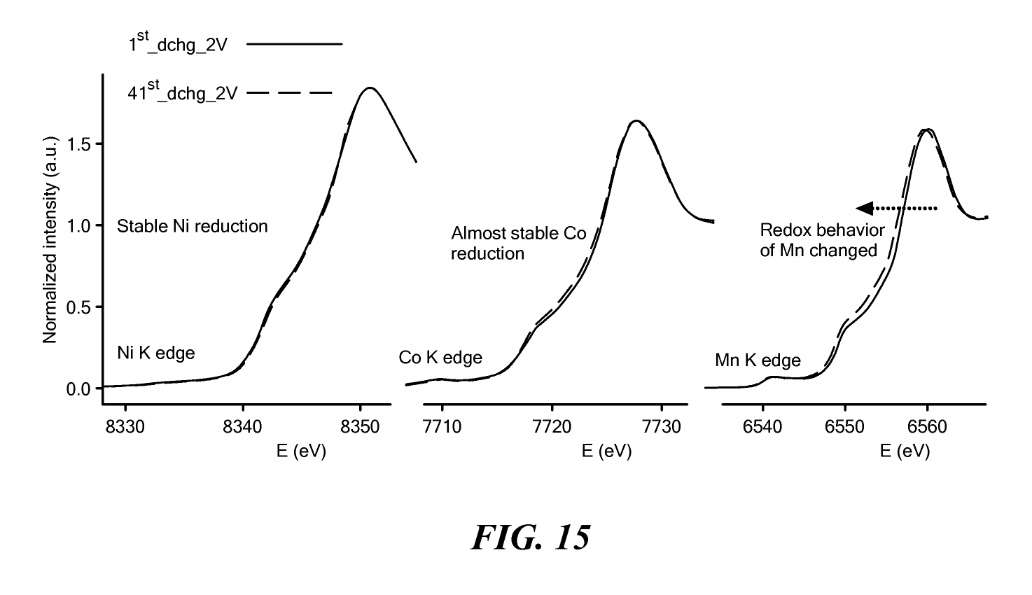

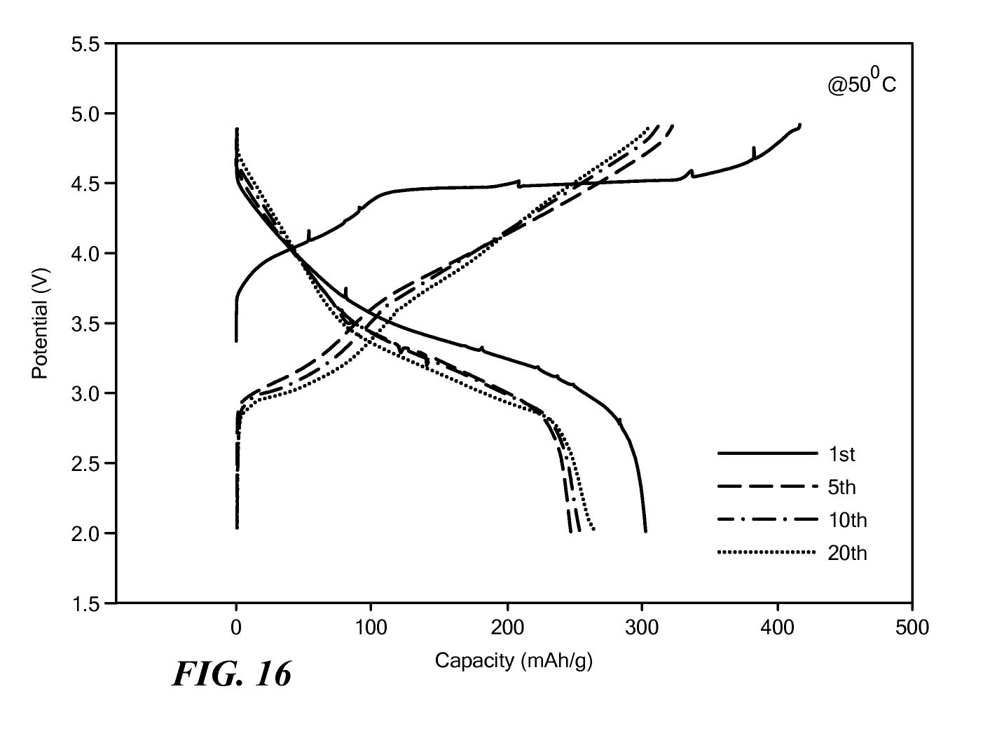

The cycled cathodes were further investigated after 41 cycles through XAS, specifically the XANES region, in order to understand the redox behavior of each transition metal. FIG. 15 shows the XANES profiles of each transition metal after the first discharge and after the 41 cycles discharged to 2 V. In general, none of the XANES shapes were affected or altered implying that the coordination environment was preserved compared to those after the 1st discharge following the activation of Li₂MnO₃. Some changes occurred as cycling continued. In contrast to Ni and Co—K edges, Mn—K edge energy value in the white-line region was shifted to lower energy value indicating that Mn reduced more and more as cycling continues. This dynamic redox behavior of Mn might appear beneficial in terms of capacity, nonetheless this leads to voltage depression at the early cycles as demonstrated in FIG. 12A and 14A. Overall, it is found that the most robust transition metal during cycling appears to be Ni and to some extent Co in terms of redox behavior and chemical environment, while Mn atoms are more susceptible to changes during cycling as its chemical environment was partially destroyed after the first cycle and its redox behavior changes as cycling continues.

As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

This application claims the priority of U.S. Provisional Application No. 62/011,634 filed 13 Jun. 2014 and entitled “Synthesis and Characterization of Cathode Material for Li-ion Battery Applications”, the whole of which is hereby incorporated by reference.

1. A cathode material for a lithium ion battery, the material comprising a layered-layered Li₂MnO₃—LiMO₂ material, wherein M is a transition metal or combination of transition metals, and wherein the material is made by a process comprising self-ignition combustion.

2. The cathode material of claim 1, wherein the transition metal is selected from the group consisting of Mn, Co, Ni, and combinations thereof.

3. (canceled)

4. The cathode material of claim 1, wherein said layered-layered Li₂MnO₃—LiMO₂ material has the formula 0.5Li₂MnO₃-0.5LiMn_{0.5}Ni_{0.35}Co_{0.15}O₂.

5. The cathode material of claim 1 having a surface area in the range from about 3.50 to about 3.95 m²/g.

6. The cathode material of claim 1 having an open interconnected micropore structure.

7. The cathode material of claim 1 having an average pore size in the range from about 150 to about 200 angstroms.

8. The cathode material of claim 1 comprising particles of about 100 nm size agglomerated to particles of about 200 nm to about 250 nm size.

9. The cathode material of claim 1 that is made by a process that does not include co-precipitation.

10. A lithium ion battery comprising the cathode material of claim 1.

11. The lithium ion battery of claim 10 that has a discharge capacity of at least 200 mAh/g at a discharge rate of C.

12. The lithium ion battery of claim 10 that has a discharge capacity of at least 245 mAh/g at a discharge rate of C/4.

13. The lithium ion battery of claim 10 that has a discharge capacity of about 280 mAh/g at a discharge rate of C/20.

14. The lithium ion battery of claim 10 that has a specific energy of at least 400 Wh/kg.

15. The lithium ion battery of claim 10 that has an energy density of at least 1000 Wh/L.

16. The lithium ion battery of claim 10 that retains essentially 100% of its initial discharge capacity after 100 charge/discharge cycles.

17. The lithium ion battery of claim 10, wherein the impedance of the battery does not substantially increase after 100 charge/discharge cycles.

18. The lithium ion battery of claim 10, wherein the DC conductivity is in the range from about 5×10⁻⁶ to about 9×10⁻⁶ S/cm.

19. A method of making a cathode material for a lithium ion battery, the method comprising the steps of:
(a) providing an aqueous solution comprising one or more transition metal salts, nitric acid, and a self-ignition combustion fuel, wherein at least one of the transition metal salts is an acetate salt;
(b) heating the solution from (a) to initiate a self-ignition combustion reaction, whereby a porous metal oxide scaffold is formed;
(c) adding a lithium precursor to the porous metal oxide scaffold from (b) to form a mixture and grinding the mixture; and
(d) heating the ground mixture from (c) to form the cathode material.

20-24. (canceled)

25. The method of claim 19, wherein the self-ignition combustion fuel is glycine.

26-30. (canceled)

31. The method of claim 19, wherein steps (a) and (b) of the method do not include co-precipitation of the transition metal(s) or the Li precursor.

32-38. (canceled)
